(19) United States
(12) Patent Application Publication
(10) Pub. No.: US 2026/0349683 A1
(43) Pub. Date: Nov. 5, 2026

(54) SYSTEMS AND METHODS FOR VALIDATED CODE GENERATION WITH COMPLIANCE ENFORCEMENT

(71) Applicant: XYCORP LTD., Malibu, CA (US)

(72) Inventors: Lamara De Brouwer, Malibu, CA (US); Geert Trooskens, Meise (BE); Walter De Brouwer, Malibu, CA (US)

(73) Assignee: XYCORP LTD., Malibu, CA (US)

(21) Appl. No.: 19/551,014

(22) Filed: Feb. 26, 2026

Related U.S. Application Data
(60) Provisional application No. 63/763,549, filed on Feb. 26, 2025.

(51) Int. Cl. G06F 8/35; G06F 11/3668

(52) U.S. Cl. CPC G06F 8/35; G06F 11/3696

(57) ABSTRACT

Techniques are disclosed for generating validated code using a language model. A system may invoke a language model to generate code within an insertion region of a code structure, the insertion region bounded by compliance-enforcing code segments. The system may validate generated code by executing a plurality of validation stages in sequence, each stage evaluating the code against stage-specific criteria. Upon failure at a validation stage, the system may generate an error context identifying the failed stage and provide the error context to the language model for regeneration. The system may compute an operational metric relating a generation cost to a runtime inference cost, and select between deploying the code artifact and runtime inference based on the metric. A deployed code artifact may include invocation points for runtime language model calls, each comprising a schema for validating output and fallback logic upon validation failure.

### PRIORITY APPLICATION

This application claims the benefit of U.S. Provisional Patent Application No. 63/763,549, filed on Feb. 26, 2025, titled “Systems and Methods for Validated Code Generation with Compliance Enforcement” (Atty. Docket No. XYAI1002USP01). The provisional application is hereby incorporated by reference for all purposes.

### BACKGROUND

### Technological Field

The present disclosure relates to systems and methods for generating software code using language models, and more particularly to validated code generation with sequential validation pipelines, compliance enforcement through template architecture, operational regime selection, and contained runtime model invocation.

### Description of Related Art

Enterprise software environments may involve workflow automation across regulated domains. Code implementing such workflows may be subject to considerations including reliability, compliance with applicable regulatory requirements, and predictable runtime behavior.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a block diagram of an example system architecture for validated code generation, in accordance with example embodiments of the disclosure.

FIG. 2 illustrates a flow diagram of an example generation and validation flow with regeneration upon validation failure, in accordance with example embodiments of the disclosure.

FIG. 3 illustrates a block diagram of an example validation pipeline comprising sequential validation stages with stage-identified error context generation, in accordance with example embodiments of the disclosure.

FIG. 4 illustrates a schematic diagram of an example template structure comprising fixed regions and a bounded insertion region for language model code generation, in accordance with example embodiments of the disclosure.

FIG. 5 illustrates a block diagram of example generation context assembly from component libraries, in accordance with example embodiments of the disclosure.

FIG. 6 illustrates a schematic diagram of an example bounded runtime invocation point with schema validation and fallback logic, in accordance with example embodiments of the disclosure.

FIG. 7 illustrates a block diagram of example compliance encoding in template architecture, in accordance with example embodiments of the disclosure.

FIG. 8 illustrates a schematic diagram of an example operational metrics framework for regime selection between code artifact deployment and runtime inference, in accordance with example embodiments of the disclosure.

FIG. 9 illustrates a block diagram of an example computing environment, in accordance with example embodiments of the disclosure.

FIG. 10 illustrates a block diagram of an example network architecture, in accordance with example embodiments of the disclosure.

FIG. 11 illustrates a block diagram of an example computing device, in accordance with example embodiments of the disclosure.

### DETAILED DESCRIPTION

The following detailed description is directed to example implementations and is not intended to limit the scope of the claims. A person of ordinary skill in the art will recognize that many variations are possible without departing from the spirit and scope of the disclosed subject matter.

Example implementations of this disclosure describe methods, apparatuses, computer-readable media, and system(s) for validated code generation using language models with sequential validation pipelines, compliance enforcement through template architecture, operational regime selection, and contained runtime model invocation. In some examples, a configuration agent may assemble generation context from component libraries comprising templates, modules, and prompt blocks, and a language model may generate code within a bounded insertion region of a selected template, such that compliance-enforcing code segments in fixed template regions structurally contain the generated code.

In some examples, an operational metric relating a cost of generating a code artifact by a language model to a cost of executing by runtime language model inference may be computed, and a selection between deploying the code artifact and executing by runtime inference may be made based on the operational metric. In some examples, the operational metric may comprise a break-even threshold at which generation cost equals cumulative inference cost across a number of executions, and the code artifact may be deployed when an expected number of executions exceeds the break-even threshold.

In some examples, a language model may be invoked to generate code within an insertion region of a code structure encoding a compliance requirement, wherein the insertion region is bounded by compliance-enforcing code segments corresponding to the compliance requirement, and a code artifact comprising the generated code within the compliance-enforcing code segments may be output. In some examples, the compliance-enforcing code segments may comprise audit logging code, encryption code, or access control code, and the code structure may be selected from a library of code structures indexed by compliance requirement.

In some examples, code generated by a language model may be validated by executing a plurality of validation stages in sequence, each validation stage evaluating the code against criteria specific to that validation stage, and upon failure at a validation stage, an error context identifying the failed validation stage may be generated and provided to the language model to regenerate the code. In some examples, the plurality of validation stages may comprise a security validation stage, a syntax validation stage, an execution validation stage, and an accuracy validation stage.

In some examples, at an invocation point defined within a code artifact, input may be transmitted to a language model and output received from the language model, the output may be validated against a schema, and upon the output failing validation, fallback logic defined within the code artifact may be executed. In some examples, the fallback logic may comprise returning a default value, retrying with modified input, or routing to a human review queue, and the invocation point may be scoped to a subtask comprising classification, extraction, or summarization.

In many implementations, the disclosed technology may improve AI-assisted code generation workflows by decoupling code generation from code execution, enabling deterministic execution of validated code artifacts while containing non-determinism within bounded invocation points.

For a given workflow specification, the system may assemble generation context from component libraries, invoke a language model to generate code within a bounded insertion region, validate the generated code through sequential validation stages, and deploy the validated artifact. Because validation may already have been performed and compliance requirements may be structurally encoded in fixed template regions, per-execution operation can reduce to deterministic code execution, with no requirement to re-invoke the language model, re-validate outputs, or re-verify compliance, except at bounded invocation points where runtime language model calls may be contained within schema-validated boundaries as described herein.

This validation-amortized operation may yield concrete time and compute savings. Many real-world workflow automations are invoked repeatedly, often tens, hundreds, or thousands of times per day. Conventional code generation systems may pay the cost of runtime language model inference on every execution, or may fall back to manual code development that may not scale to large numbers of workflows. By contrast, the disclosed system may amortize generation and validation cost over the lifetime of the artifact: once code has been generated and validated, subsequent executions may reuse the validated artifact without re-running generation or validation. This may significantly reduce token consumption, latency, and computational resources required for each execution, and may enable high-volume workflows to operate with deterministic performance characteristics even for complex business logic.

In some examples, the operations described herein may involve computational tasks that exceed the capacity of manual human effort or mental processes. For example, the validation pipeline may execute sequential validation stages comprising security scanning of generated code against pattern-matching rules and abstract syntax tree analysis, syntax validation with type checking across function calls and variable assignments, execution of the generated code in a sandboxed environment with resource limits and monitored runtime behavior, and accuracy comparison of code outputs against reference data across multiple test inputs, all within bounded computational time and resource constraints. The break-even threshold computation may relate token costs, computational costs, and variability measures across continuous cost variables for each workflow specification in a portfolio of potentially hundreds or thousands of workflows. Schema validation at bounded invocation points may validate language model outputs against defined schemas comprising required fields, expected data types, and acceptable value patterns at runtime latency constraints measured in milliseconds. The assembly of generation context from component libraries comprising templates, modules, and prompt blocks, combined with the enforcement of bounded insertion regions through generation-time instruction, assembly-time extraction, and validation-time verification, may involve coordinated processing across multiple system components operating on structured data representations that may not be practically replicated through manual effort.

In some examples, the output of the system may drive downstream technical operations without requiring intermediate human review or decision-making. For example, a validated code artifact stored in the artifact repository may be provided directly to a workflow execution engine, which may execute the artifact against incoming workflow requests such as prior authorization determinations, document classifications, or claims processing decisions. The workflow execution engine may retrieve the validated code artifact and may execute it in response to each incoming request, producing outputs that may be transmitted to downstream systems such as databases, external APIs, or notification services. Because the code artifact may have been validated through the sequential validation stages prior to deployment, the workflow execution engine may execute the artifact without re-invoking the language model or re-running validation, and the outputs may be consumed by downstream systems as automated operational results rather than as informational displays requiring human interpretation.

The disclosed technology may also improve the precision of error diagnosis by operating at the level of validation stage, rather than treating validation as a single pass/fail gate. During validation, the system may execute sequential stages with stage-specific criteria, identifying the actual validation stage that failed along with diagnostic context specific to that stage type.

Because error context may be grounded in stage-level identification, regeneration feedback can distinguish between security failures and accuracy failures. In some implementations, the system may further classify failures into categories such as “security violation,” “syntax error,” “execution failure,” or “accuracy mismatch,” based on which validation stage produced the failure, providing targeted feedback beyond a binary pass/fail result that enables qualitatively different remediation strategies.

Modern enterprise workflows increasingly benefit from AI-assisted automation. Code generation systems may need to determine not only whether a language model can produce syntactically correct code, but also whether the generated code is secure, executes correctly, produces accurate outputs, and complies with applicable regulatory requirements across multiple compliance frameworks.

In one approach, the system invokes a language model at runtime for each workflow execution. These runtime-inference workflows may be computationally expensive, consuming tokens on every execution, and may produce non-deterministic outputs that vary across invocations. This non-determinism may prevent reliable audit trails from being maintained and may introduce unpredictable latency into time-sensitive workflows.

In another approach, code generation tools may validate generated code in a single pass, reporting only whether the code passed or failed without distinguishing the type of failure. When validation fails, these systems may provide generic error messages that do not indicate whether the failure was due to a security vulnerability, a syntax error, a runtime exception, or an output accuracy problem. Both approaches may suffer from efficiency and reliability limitations: runtime inference systems may not scale cost-effectively to high-volume workflows, and single-pass validation approaches may not provide actionable feedback for targeted regeneration.

Furthermore, many existing systems do not enforce compliance at the structural level. Different regulatory frameworks such as HIPAA for healthcare data, SOC 2 for security controls, and PCI-DSS for payment card data may require different enforcement mechanisms including audit logging, encryption, and access control. When a system relies on the language model to generate compliant code directly, rather than structurally enforcing compliance through template architecture, it may produce code that violates requirements not apparent to the model or not represented in the generation context.

The presence of necessary runtime language model calls for judgment tasks such as classification, extraction, and summarization may exacerbate reliability problems, because outputs from such calls may be non-deterministic and may not conform to expected schemas. As a result, many conventional systems may either prohibit runtime language model calls entirely, limiting the flexibility of generated workflows, or permit unconstrained calls that introduce non-determinism propagating through the system without bounds.

In short, there may be a need for a computer-implemented code generation technique that (i) decouples generation cost from execution frequency through an operational metrics framework, (ii) validates generated code through sequential stages that provide stage-identified feedback for targeted regeneration, (iii) enforces compliance through structural containment in template architecture rather than relying on model behavior, and (iv) contains runtime language model calls within bounded invocation points with schema validation and deterministic fallback logic.

The disclosed technology may address these problems by generating validated code artifacts at compile time and deploying those artifacts for deterministic execution, with runtime language model calls contained within bounded invocation points that enforce schema conformance and provide fallback behavior.

In one aspect, a computer-implemented method may compute an operational metric relating a cost of generating a code artifact by a language model from a workflow specification to a cost of executing the workflow specification by runtime language model inference. In some implementations, the operational metric comprises a break-even threshold at which the cost of generating the code artifact equals a cumulative cost of executing the workflow specification by runtime inference across a number of executions. Based on the operational metric, the system may select between deploying the generated code artifact and executing the workflow specification by runtime inference. In some implementations, selecting comprises deploying the code artifact when an expected number of executions exceeds the break-even threshold. In other implementations, the operational metric further comprises an output variability measure representing variation in outputs across repeated runtime inference executions, favoring artifact deployment when inference outputs are highly variable.

In another aspect, the system may invoke a language model to generate code within an insertion region of a code structure encoding a compliance requirement. The insertion region may be bounded by compliance-enforcing code segments corresponding to the compliance requirement. Because the language model generates code only within the bounded insertion region, and because compliance-enforcing code segments in fixed header and footer regions surround that insertion region, the generated code inherits compliance properties by structural containment. In some examples, the compliance requirement comprises at least one of HIPAA, SOC 2, or PCI-DSS. In some examples, the compliance-enforcing code segments comprise audit logging code, encryption code, or access control code. In other examples, the system selects the code structure from a library of code structures indexed by compliance requirement. Hybrid approaches combining multiple compliance frameworks are also possible.

In a further aspect, the system may validate code generated by a language model by executing a plurality of validation stages in sequence, each validation stage evaluating the code against criteria specific to that validation stage. In some implementations, the plurality of validation stages comprises a security validation stage configured to detect unsafe code patterns including injection vulnerabilities and hardcoded credentials, a syntax validation stage configured to verify code structure and type correctness, an execution validation stage configured to execute the code in a sandboxed environment with resource limits, and an accuracy validation stage configured to compare outputs of the code against reference data. Upon failure at a validation stage of the plurality, the system generates an error context identifying the failed validation stage. In some implementations, the error context further comprises a line number associated with the failure, an error message, or a failing test case identifier. The system provides the error context to the language model to regenerate the code. In some implementations, upon a count of regenerations exceeding a threshold, the system routes the code for human review rather than continuing automated regeneration.

In yet another aspect, at an invocation point defined within a code artifact, the system may transmit input to a language model and receive output from the language model. The system validates the output against a schema. In some implementations, the schema defines at least one of required fields, expected data types, or acceptable value patterns. Upon the output failing validation against the schema, the system executes fallback logic defined within the code artifact. In various examples, the fallback logic comprises returning a default value, retrying with modified input, or routing to a human review queue. In some implementations, the invocation point is scoped to a subtask comprising at least one of classification, extraction, or summarization. In some implementations, the system also validates input against an input schema prior to transmitting the input to the language model.

The generation and validation may be performed for a plurality of different workflow specifications, and the system may store respective validated code artifacts prior to any particular execution. As a result, when an execution later invokes any of these workflows, the system can execute the validated artifact rather than performing generation and validation from scratch, amortizing the one-time generation cost across many executions.

In some examples, the code artifact, upon deployment, may execute the workflow specification from stored code without re-invoking the language model for generation or re-executing the validation pipeline. Because the code artifact may have been generated by the language model, validated through the plurality of validation stages, and stored in the artifact repository prior to any execution request, subsequent executions may retrieve and execute the stored code artifact rather than performing generation and validation from scratch. The stored code artifact may contain the generated business logic assembled within the template structure, including the compliance-enforcing code segments in the fixed header and footer regions, such that the artifact may be executed as a self-contained unit of stored code. At bounded invocation points within the artifact, the system may invoke a language model for defined subtasks as described herein, but the business logic outside those bounded invocation points may execute from the stored code without language model involvement.

In some implementations, the system may monitor an output distribution from bounded invocation points and trigger regeneration of the code artifact upon detected drift in the output distribution, such that artifacts remain aligned with current language model behavior over time. As used herein, the terms ‘code artifact’ refer to code that has been generated for execution, regardless of whether the code is executed by a compiler, an interpreter, a bytecode virtual machine, or another execution mechanism.

The techniques may be implemented in a system comprising one or more processors and memory storing instructions that, when executed by the one or more processors, cause the system to perform the described operations.

In some examples, the system may expose an application programming interface that accepts workflow specifications and returns validated code artifacts or execution results, allowing external tools to invoke generation and execution without replicating the underlying validation logic.

In some examples, the system may produce output in structured formats consumable by external systems and operators. The artifact repository may expose a query interface that returns metadata for stored artifacts, including the workflow specification identifier, the language model version used for generation, the validation results for each stage, the number of regeneration attempts, and the timestamp of generation. In some examples, the system may produce validation pipeline status outputs indicating which validation stages passed or failed for a given generation attempt, along with the diagnostic information generated at each stage. In some examples, the system may produce operational metrics outputs comprising the computed generation cost, the computed runtime inference cost, the break-even threshold, and the regime selection result for each workflow specification. These outputs may be formatted as structured data objects such as JSON documents and may be transmitted to monitoring dashboards, logging systems, or operational data stores.

The disclosed technology may provide concrete technical improvements to computer-implemented code generation systems, rather than merely reorganizing abstract workflow information or automating manual processes.

Because validation may be performed per code artifact at generation time, the system can respond to execution requests using the validated artifact, without re-invoking the language model and without re-running validation stages. This may reduce token consumption and latency at runtime, enabling high-volume workflows to execute with deterministic performance characteristics that would not be achievable with per-execution inference.

In one implementation, a deployed code artifact exhibited execution latency of approximately 5 milliseconds at the 50th percentile and approximately 11 milliseconds at the 99th percentile, compared to approximately 3,400 milliseconds at the 50th percentile and approximately 5,000 milliseconds at the 99th percentile for runtime language model inference performing the same workflow. The deployed artifact exhibited execution latency jitter of approximately 6 milliseconds compared to approximately 1,600 milliseconds for runtime inference. The generation phase required a one-time compilation duration of approximately 31 seconds. These measurements illustrate the latency characteristics achievable when workflow execution does not require runtime network calls, model inference, or stochastic processing.

By identifying the specific validation stage that failed, rather than reporting only a binary pass/fail result, the system may enable targeted regeneration that addresses the actual failure mode. When the system distinguishes security failures from syntax failures from execution failures from accuracy failures, it may provide context that enables qualitatively different remediation strategies. For example, a security failure may require removing dangerous patterns while an accuracy failure may require adjusting output formatting. This targeted feedback may improve convergence to valid code with fewer regeneration attempts.

The use of structural containment for compliance enforcement may promote satisfaction of compliance properties regardless of language model behavior within the bounded insertion region. Because compliance-enforcing code segments may execute unconditionally in the fixed template regions, and because generated code may not modify those regions, compliance outcomes may be more reliable than approaches that rely on the language model to generate compliant code directly or that perform post-hoc compliance checking on generated output.

Containment of runtime language model calls within bounded invocation points with schema validation and fallback logic may promote deterministic system behavior even when language model outputs are non-conforming. By defining acceptable output patterns in schemas and providing fallback paths for non-conforming outputs, the system may reduce failure propagation that might otherwise require manual intervention or might produce inconsistent workflow results.

The generation-time investment in validation may be amortized across many executions of the same workflow. This may produce a tangible performance improvement at the systems level, particularly in environments where workflows are executed repeatedly. The break-even analysis enables rational selection between the upfront cost of generation and the per-execution cost of inference.

The exposed API may allow other tooling to integrate validated code generation into development pipelines, continuous integration systems, or workflow management platforms without duplicating the underlying validation infrastructure. Collectively, these features may improve how conventional computing systems execute AI-assisted code generation workflows by enabling more reliable, more scalable code production using fewer runtime resources and across a broader class of workflows than may be practical with runtime-inference-only or unvalidated approaches.

The following examples illustrate various implementations and use cases enabled by the present disclosure. These examples are provided for illustration and are not intended to limit the scope of the claims. In various implementations, the methods and systems described herein may be applied to different workflow domains, compliance frameworks, language model configurations, and deployment contexts.

In one implementation, a healthcare workflow automation system may receive a workflow specification for a prior authorization process. The configuration agent may parse the specification and determine that the workflow requires database connectivity for patient records, HTTP integration for payer API calls, and HIPAA compliance for protected health information. The configuration agent may select a ValidatorAgent template from the template library, the template encoding HIPAA-compliant audit logging in its header region and encrypted data handling in its footer region. The configuration agent may further select DatabaseModule and HTTPModule from the module library, and HIPAA prompt blocks from the prompt block library specifying minimum necessary access requirements and disclosure limitations.

The system may assemble a generation context comprising the selected template with its bounded insertion region demarcated, the module interfaces exposing database query and HTTP request functions, and the HIPAA prompt blocks constraining the business logic. The system may invoke the language model with this generation context, and the language model may generate approximately 35 lines of business logic implementing the prior authorization decision workflow within the bounded insertion region. Because the HIPAA-compliant audit logging may execute unconditionally in the template header and the encrypted transmission may execute unconditionally in the template footer, the generated business logic inherits HIPAA compliance by structural containment regardless of whether the language model explicitly considered HIPAA requirements when generating the code.

The validation pipeline may then execute four stages in sequence. The security validation stage may scan the generated code for injection vulnerabilities and verify that no hardcoded credentials or unauthorized network endpoints appear. The syntax validation stage may parse the code and verify type correctness of function calls to the database and HTTP modules. The execution validation stage may execute the code in a sandboxed environment with simulated patient records and payer responses, monitoring for runtime exceptions. The accuracy validation stage may compare the authorization decisions produced by the code against reference decisions for a test suite of prior authorization scenarios. Upon all stages passing, the system may output a validated code artifact to the artifact repository for deployment.

From a technical standpoint, this implementation may reduce per-execution cost by reducing or eliminating runtime language model inference for each prior authorization request. Because the healthcare organization may process thousands of prior authorization requests daily, the break-even threshold may be exceeded within the first day of deployment, making artifact deployment substantially more economical than runtime inference. The structural enforcement of HIPAA compliance may provide stronger compliance properties than approaches relying on language model behavior or post-hoc compliance scanning.

In another implementation, the validation pipeline may encounter a failure during code generation for a claims processing workflow. The language model may generate code that passes the security validation stage and the syntax validation stage but fails the execution validation stage due to a runtime exception when processing claims with specific modifier codes. The execution validation stage may generate an error context comprising a stage identifier indicating “execution validation,” a line number indicating the failing statement, and an exception message indicating “KeyError: modifier_code_59.”

The system may provide this error context to the language model for regeneration. Because the error context identifies the failure as an execution-stage failure with a specific missing key, the language model may focus its regeneration on adding handling for the modifier code case rather than re-examining security patterns or syntax structure. The language model may generate revised code that includes conditional handling for modifier codes. The validation pipeline may re-execute all four stages on the revised code. The revised code may pass all stages, and the system may output the validated artifact.

In some cases, the regenerated code may pass the execution validation stage but fail the accuracy validation stage due to incorrect handling of the modifier code logic. The accuracy validation stage may generate a new error context comprising a stage identifier indicating “accuracy validation” and a failing test case identifier indicating the specific modifier code scenario. The system may provide this new error context to the language model for a second regeneration attempt. Because the error context now identifies an accuracy failure rather than an execution failure, the language model may focus on adjusting the business logic rather than the exception handling.

Additionally or alternatively, after a configured number of regeneration attempts (for example, three attempts), the system may route the code for human review rather than continuing automated regeneration. A human reviewer may examine the error context history showing the progression from execution failure to accuracy failure and may provide guidance or manual corrections. This escalation mechanism may prevent infinite regeneration loops while preserving human oversight for cases that exceed the language model's ability to self-correct.

From a technical standpoint, the stage-identified feedback may reduce the average number of regeneration attempts required to produce valid code compared to approaches that provide only binary pass/fail feedback. By indicating not only that validation failed but which type of validation failed, the system may enable targeted remediation that converges more efficiently to valid code.

In one implementation, a code generation system achieved a compilation success rate of approximately 97 percent across a set of 214 function-calling workflow specifications, meaning that approximately 97 percent of workflow specifications produced validated code artifacts that passed all four validation stages. Workflow specifications that did not produce validated artifacts were detected during validation and did not proceed to deployment, illustrating that the validation pipeline identifies failures before deployment rather than at runtime.

In yet another implementation, the system may apply the operational metrics framework to select between artifact deployment and runtime inference for a document classification workflow. The workflow specification may define a classification task that categorizes incoming documents into regulatory categories. The system may compute a generation cost comprising token costs for the initial generation attempt, token costs for two regeneration attempts that occurred before validation succeeded, and computational costs for validation pipeline execution across all attempts. The system may compute a runtime inference cost comprising token costs for a single classification inference and latency costs representing delay in document processing.

The system may compute a break-even threshold by dividing the generation cost by the runtime inference cost. For example, if generation cost totals 50,000 tokens and runtime inference cost is 500 tokens per classification, the break-even threshold may be 100 classifications. The system may compare an expected number of classifications to this threshold. If the document classification workflow is expected to process 10,000 documents per month, the expected execution count substantially exceeds the break-even threshold, and the system may select deployment of the validated code artifact.

In one implementation, a code generation system generated a code artifact for a function-calling workflow, consuming approximately 11,000 tokens during generation including prompt tokens and output tokens. The corresponding runtime inference approach consumed approximately 500 tokens per execution. The break-even threshold was approximately 22 executions (11,000/500). At 100 executions, the code artifact approach consumed approximately 11,000 total tokens compared to approximately 50,000 tokens for the runtime inference approach, representing approximately a 4.5 times reduction in token consumption. At 1,000 executions, the code artifact approach consumed approximately 11,000 total tokens compared to approximately 500,000 tokens for the runtime inference approach, representing approximately a 45 times reduction in total token consumption. The ratio of prompt tokens consumed during generation to lines of generated code was approximately 11 to 1.

Alternatively, for a rarely-used workflow (for example, a quarterly compliance report generator expected to execute four times per year), the expected execution count may fall below the break-even threshold. The system may select runtime inference for this workflow, avoiding the upfront generation and validation cost that would not be amortized across sufficient executions.

In some implementations, the operational metrics framework may further consider output variability. For the document classification workflow, the system may determine that runtime inference produces inconsistent category assignments across repeated classifications of the same document. This variability may increase the effective runtime inference cost by introducing risk of inconsistent audit trails. The system may adjust the break-even calculation to favor artifact deployment even at lower expected execution counts when output variability is high.

From a technical standpoint, the operational metrics framework may enable rational resource allocation across a portfolio of workflows. Workflows with high execution frequency and low tolerance for output variability may be deployed as validated artifacts, while workflows with low execution frequency may use runtime inference, optimizing total system cost across both generation and execution phases.

In a further implementation, a validated code artifact for a medical records summarization workflow may include a bounded invocation point for runtime language model calls. The workflow may retrieve patient records from a database, and the generated code may deterministically extract structured fields such as dates, diagnosis codes, and medication lists. However, the workflow specification may also require generating a narrative summary of the patient's treatment history, a task requiring language model judgment that may not be fully determined at generation time.

The code artifact may define an invocation point for the summarization subtask. The invocation point may comprise an input schema specifying that input must include a patient identifier, a list of structured medical events, and a maximum summary length. The invocation point may further comprise an output schema specifying that output must include a summary text field of string type, a confidence score field of numeric type between 0 and 1, and an array of cited event identifiers. The code artifact may validate input against the input schema prior to invoking the language model, rejecting malformed requests before incurring inference cost.

Upon receiving output from the language model, the system may validate the output against the output schema. If the language model returns a summary without a confidence score, or returns a confidence score outside the 0-to-1 range, or returns cited event identifiers that do not correspond to events in the input, the output may fail schema validation. The system may execute fallback logic defined in the code artifact. In one configuration, the fallback logic may retry the language model with a modified prompt emphasizing the required output format. In another configuration, the fallback logic may return a default summary comprising a structured list of events without narrative synthesis. In yet another configuration, the fallback logic may route the summarization request to a human review queue for manual summary generation.

Additionally or alternatively, the system may monitor output distributions from the bounded invocation point over time. If the language model's confidence scores drift (for example, if confidence scores that previously averaged 0.85 begin averaging 0.60), the system may trigger artifact regeneration to realign the workflow with current language model behavior. This drift monitoring may maintain workflow reliability as underlying language models are updated or replaced.

From a technical standpoint, the bounded invocation point may enable the code artifact to leverage runtime language model capabilities for judgment tasks while containing non-determinism within observable boundaries. The schema validation may be configured so that downstream code receives conforming data regardless of language model behavior. The fallback logic may be configured so that the workflow produces a result even when the language model fails to conform, maintaining system reliability. The drift monitoring may be configured so that artifacts remain aligned with language model behavior over the deployment lifetime.

These working examples illustrate how the disclosed technology may be applied to healthcare workflows, claims processing, document classification, and medical records summarization. It should be understood that these examples are illustrative and not limiting; other workflow domains including financial services, insurance, supply chain, and customer service are contemplated and within the scope of this disclosure. The technical benefits of compliance by structural containment, stage-identified regeneration, operational regime selection, and bounded runtime invocation may apply regardless of the specific workflow domain or compliance framework. Different language models, template architectures, validation criteria, and fallback strategies may be employed while still realizing the benefits of the disclosed technology. Specific numeric values, ranges, thresholds, percentages, and quantities described herein are illustrative and not limiting unless explicitly recited in the claims.

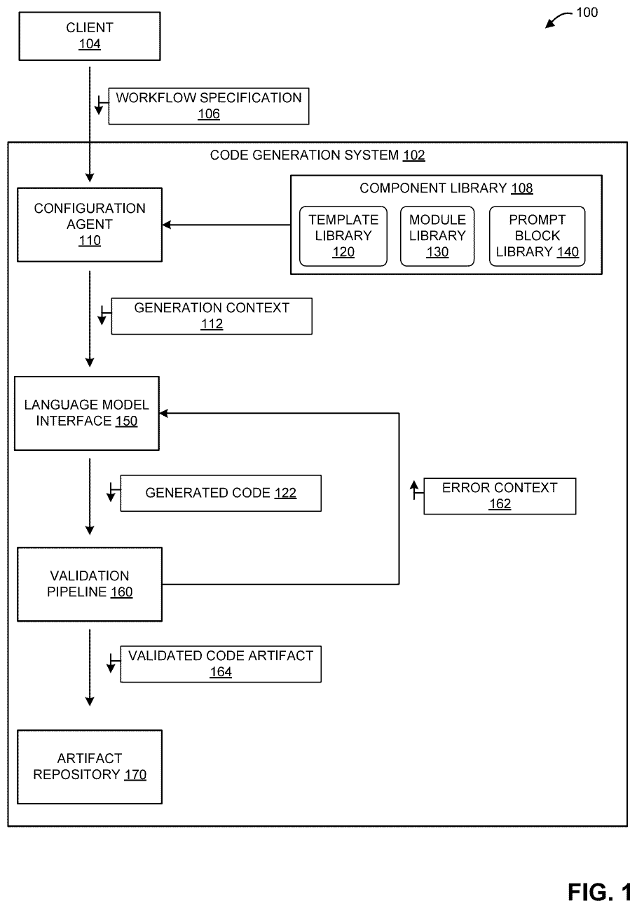

Certain implementations of the disclosure will now be described more fully below with reference to the accompanying figures, in which various aspects are shown. In particular, the following sections describe an example environment, system components, and processing flows in further detail with reference to FIGS. 1-11. However, the various aspects may be implemented in many different forms and should not be construed as limited to the implementations set forth herein. It will be appreciated that the disclosure encompasses variations of the implementations, as described herein. Like numbers refer to like elements throughout.

FIG. 1 illustrates a block diagram of a system environment for validated code generation, in accordance with example embodiments of the disclosure. The environment 100 may comprise a client 104 and a code generation system 102. The client 104 may transmit a workflow specification 106 to the code generation system 102.

The code generation system 102 may comprise a configuration agent 110, a component library 108, a language model interface 150, a validation pipeline 160, and an artifact repository 170. The component library 108 may comprise a template library 120, a module library 130, and a prompt block library 140.

The client 104 may comprise a web application, a mobile application, a command-line interface, a programmatic API client, or another system that submits workflow specifications to the code generation system 102. In some examples, the client 104 may submit a workflow specification 106 for initial code generation. In other examples, the client 104 may request execution of a previously generated and validated code artifact stored in the artifact repository 170. When the client 104 requests execution of an existing workflow, the code generation system 102 may retrieve the corresponding validated code artifact from the artifact repository 170 and may execute it and may not re-invoke the language model or re-run the validation pipeline, thereby amortizing the cost of generation and validation across multiple executions.

The configuration agent 110 may receive the workflow specification 106 from the client 104. In one example, the workflow specification 106 may comprise a YAML document defining workflow parameters, data sources, integration endpoints, and compliance requirements. In other examples, the workflow specification 106 may comprise a JSON document, an XML document, or another machine-readable format. The workflow specification 106 may define an input schema specifying the data the workflow receives, an output schema specifying the data the workflow produces, one or more compliance requirements identifying applicable regulatory frameworks, integration endpoints identifying external systems with which the workflow communicates, and optionally one or more invocation points identifying subtasks that require runtime language model judgment.

The configuration agent 110 may parse the workflow specification 106 and may select components from the component library 108 based on the workflow parameters. In one example, the configuration agent 110 may implement a rule-based selection process that maps workflow characteristics to component selections. For example, the configuration agent 110 may identify that a workflow specification 106 references database connectivity and may select a DatabaseModule from the module library 130, or may identify a HIPAA compliance requirement and may select a HIPAA-compliant template from the template library 120. In another example, the configuration agent 110 may employ a scoring or ranking mechanism that evaluates multiple candidate components against the workflow specification 106 and may select the highest-scoring candidates. In yet another example, the configuration agent 110 may employ a language model to analyze the workflow specification 106 and may recommend component selections. The configuration agent 110 may resolve conflicts when the workflow specification 106 implies incompatible component selections, for example by applying priority rules, selecting the more restrictive option, or flagging the conflict for human review.

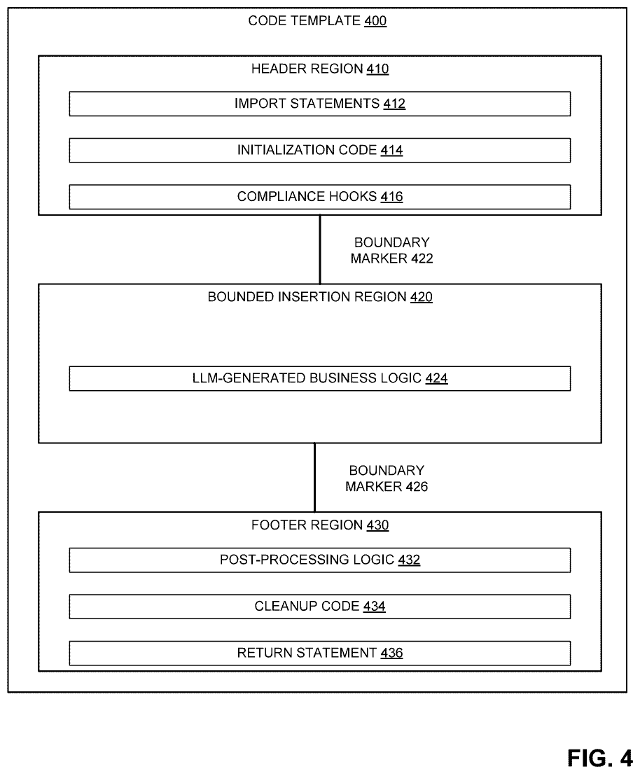

The template library 120 may store a plurality of code templates, each template may define a code structure for a particular execution pattern. In one example, the template library 120 may include templates such as SimpleAgent for single-step request-response workflows, StreamingAgent for workflows that process data in a continuous stream, ValidatorAgent for workflows that require multi-stage validation of intermediate results, and BatchAgent for workflows that process collections of items in bulk. Each template may comprise fixed code regions and a bounded insertion region, as described further with reference to FIG. 4. In some examples, templates in the template library 120 may be versioned, enabling the configuration agent 110 to select a specific template version or to default to the most recent version. New templates may be authored by developers and added to the template library 120 to support additional execution patterns without modifying the configuration agent 110 or the language model interface 150.

The module library 130 may store functional modules that may provide discrete capabilities. In one example, the module library 130 may include modules such as DatabaseModule for database connectivity including connection pooling, query parameterization, and transaction management; HTTPModule for external API integration including request construction, retry logic, and response parsing; and NotificationModule for alert and messaging functionality including email, SMS, and webhook delivery channels. Each module may expose a defined interface specifying the functions and parameters available to generated code. The configuration agent 110 may select modules based on capabilities indicated by the workflow specification 106. In some examples, the module library 130 may include additional modules such as a CacheModule for caching intermediate results, a FileModule for file system operations, or a QueueModule for asynchronous message processing. Modules may be composed, such that a generated workflow may use multiple modules concurrently. In one example, modules may encapsulate connection management and resource lifecycle, so that generated code need not manage connections, retries, or cleanup directly.

The prompt block library 140 may store prompt fragments encoding domain logic and compliance constraints. In one example, prompt blocks may encode regulatory requirements such as HIPAA for healthcare data handling, SOC 2 for security controls, and PCI-DSS for payment card data protection. Prompt blocks may also encode domain-specific business rules, output formatting requirements, error handling conventions, and security constraints. In some examples, prompt blocks may be parameterized, accepting values from the workflow specification 106 that customize the prompt fragment for the specific workflow. For example, a HIPAA prompt block may accept a parameter specifying which categories of protected health information the workflow will access, enabling the prompt to constrain the generated code accordingly. The configuration agent 110 may assemble selected prompt blocks into a generation context 112 provided to the language model interface 150. The generation context 112 may comprise the selected template, module interfaces, and prompt blocks assembled by the configuration agent 110. In some examples, the configuration agent 110 may order prompt blocks within the generation context 112 according to a priority scheme, placing compliance constraints before domain logic to emphasize regulatory requirements to the language model.

The language model interface 150 may transmit the generation context 112 to a language model and may receive generated code 122 in response. The generated code 122 may be constrained to a bounded insertion region within the selected template, as described with reference to FIG. 4. In one example, the language model interface 150 may support multiple language models and may select among them based on the complexity of the workflow specification 106, the required output quality, or cost constraints. The language model interface 150 may further specify inference parameters for each language model invocation. In one example, the language model interface 150 may set a temperature parameter to zero for code generation invocations, producing deterministic or near-deterministic output for a given generation context. Because the system may rely on the validation pipeline 160 to verify correctness rather than on sampling diversity to explore solution space, low-temperature generation that maximizes output consistency may be preferred. In some examples, the language model interface 150 may set a maximum output token parameter to constrain the length of generated code, preventing the language model from generating code that exceeds the bounded insertion region or that produces unnecessarily verbose implementations. In other examples, the language model interface 150 may adjust inference parameters per invocation, for example using a temperature of zero for initial generation and a slightly higher temperature for regeneration attempts following repeated failures at the same validation stage, to encourage the language model to explore alternative implementations when its initial approach has not converged. For example, the language model interface 150 may route simpler workflow specifications to a smaller, faster model and more complex specifications to a larger, more capable model. In one implementation, the language model interface 150 may invoke a large language model such as Claude by Anthropic, GPT by OpenAI, Gemini by Google, or another commercially available or open-source language model capable of generating executable code from natural language instructions and structured context. The system is not limited to any particular language model and may be configured to use different models for different workflow specifications or different stages of the generation process. In some examples, the language model interface 150 may implement retry logic at the interface level, retrying a language model invocation upon timeout or transient error before propagating the failure to the validation pipeline 160. In other examples, the language model interface 150 may transmit the generation context 112 in a structured format comprising a system prompt encoding the template and compliance constraints, a user prompt encoding the workflow specification and module interfaces, and optionally one or more few-shot examples drawn from example code in the generation context 112.

To illustrate, in one example the language model interface 150 may construct a prompt comprising three sections. A system prompt section may instruct the language model on its role and constraints, for example: “You are a code generation agent. Generate Python code that implements the specified business logic within the bounded insertion region. Do not modify code outside the boundary markers. Use only the module interfaces provided. Return only the code between the boundary markers.” A context section may comprise the selected template 510 with its header region, boundary markers, and footer region presented in full so that the language model may see the initialization code, available variables, and expected return types. The context section may further comprise the modular imports 520 presented as function signatures with type annotations and brief descriptions, and the prompt instructions 530 comprising domain constraints, compliance rules, and output specifications. A user prompt section may comprise the workflow specification 106 or a structured summary thereof, describing the specific business logic to be implemented. In some examples, the prompt may further include one or more few-shot examples comprising paired inputs and outputs, where each example may show a workflow specification excerpt and the corresponding generated business logic that was previously validated, enabling the language model to infer the expected code style, structure, and conventions.

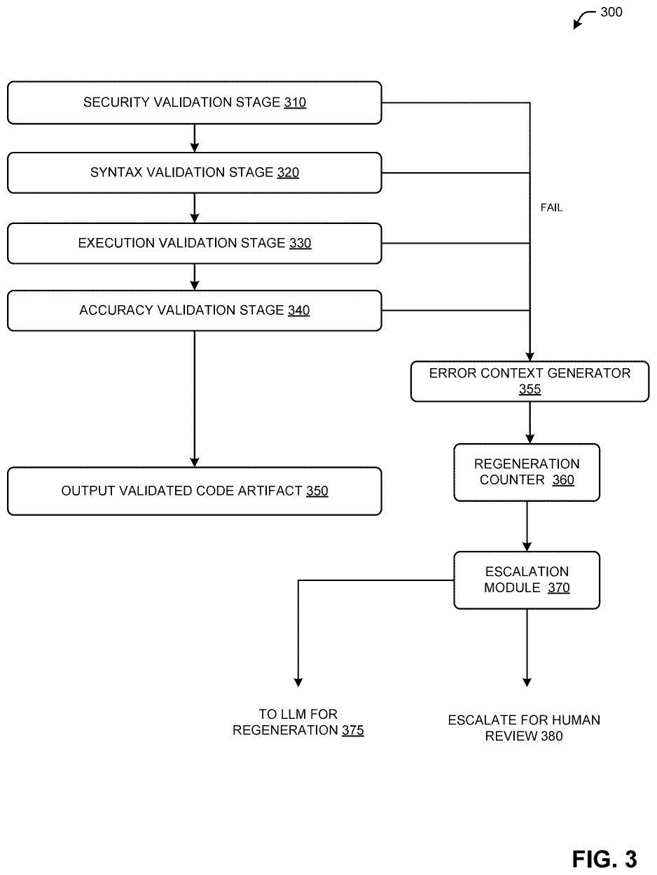

The validation pipeline 160 may receive the generated code 122 and may execute a plurality of validation stages in sequence, as described further with reference to FIG. 3. Upon successful validation, the validation pipeline 160 may output a validated code artifact 164 to the artifact repository 170. Upon validation failure, the validation pipeline 160 may generate error context 162 identifying the failed validation stage and may provide the error context 162 to the language model interface 150 for regeneration.

The artifact repository 170 may store validated code artifacts for deployment. In one example, the artifact repository 170 may maintain version history and may associate each validated code artifact with the workflow specification 106 from which it was generated. In some examples, the artifact repository 170 may store multiple versions of a validated code artifact for the same workflow specification 106, enabling rollback to a previous version if a newer version exhibits unexpected behavior in production. In other examples, the artifact repository 170 may store metadata with each validated code artifact, including the language model version used for generation, the validation results for each stage, the number of regeneration attempts required, the total generation cost, and the timestamp of generation. This metadata may support auditing, debugging, and operational metrics computation. In some examples, the artifact repository 170 may implement deduplication, detecting when a workflow specification 106 that is identical or substantially similar to a previously processed specification is submitted, and returning the existing validated code artifact rather than re-invoking the generation and validation pipeline. In yet other examples, the artifact repository 170 may expose an interface that allows external systems to query the status of stored artifacts, retrieve artifacts by workflow specification identifier, or trigger regeneration of existing artifacts in response to changes in the underlying language model or template library.

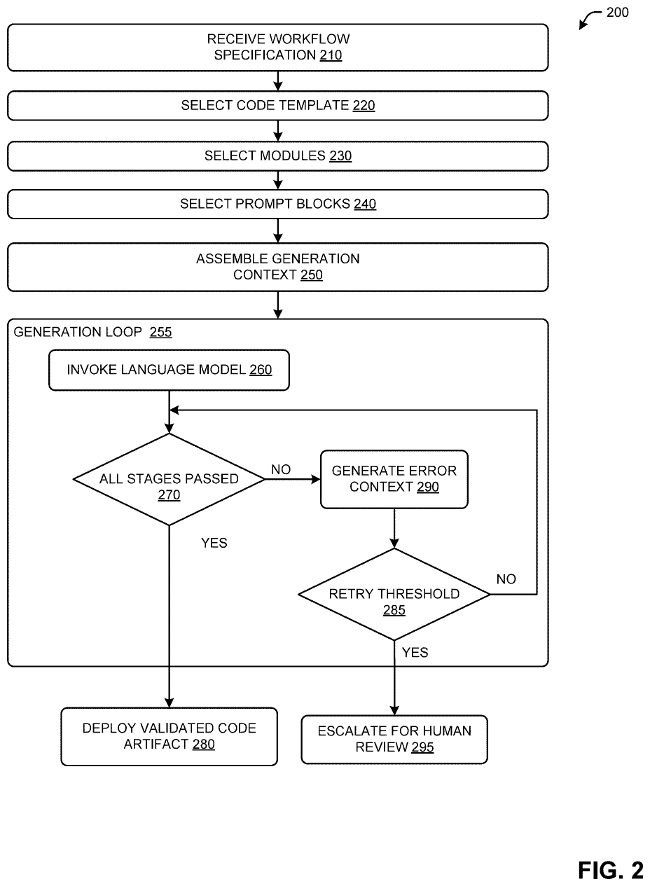

FIG. 2 illustrates a flow diagram of a generation and validation flow, in accordance with example embodiments of the disclosure. The flow 200 may describe the process by which the code generation system 102 may receive a workflow specification, may assemble a generation context, may invoke a language model, may validate the generated code, and may either deploy a validated artifact or escalate for human review.

The flow 200 may begin at block 210 where the configuration agent 110 may receive a workflow specification 106 from the client 104. In one example, the configuration agent 110 may validate the workflow specification 106 against a specification schema prior to proceeding, rejecting malformed or incomplete specifications with an error message indicating the missing or invalid fields. In some examples, the configuration agent 110 may normalize the workflow specification 106, for example by resolving shorthand notation, expanding default values, or canonicalizing compliance requirement identifiers. In other examples, the configuration agent 110 may check the artifact repository 170 at this stage to determine whether a validated code artifact already exists for the received workflow specification 106. If a matching artifact exists and has not been invalidated, the configuration agent 110 may return the existing artifact to the client 104 without proceeding through the generation and validation flow, thereby avoiding redundant generation cost.

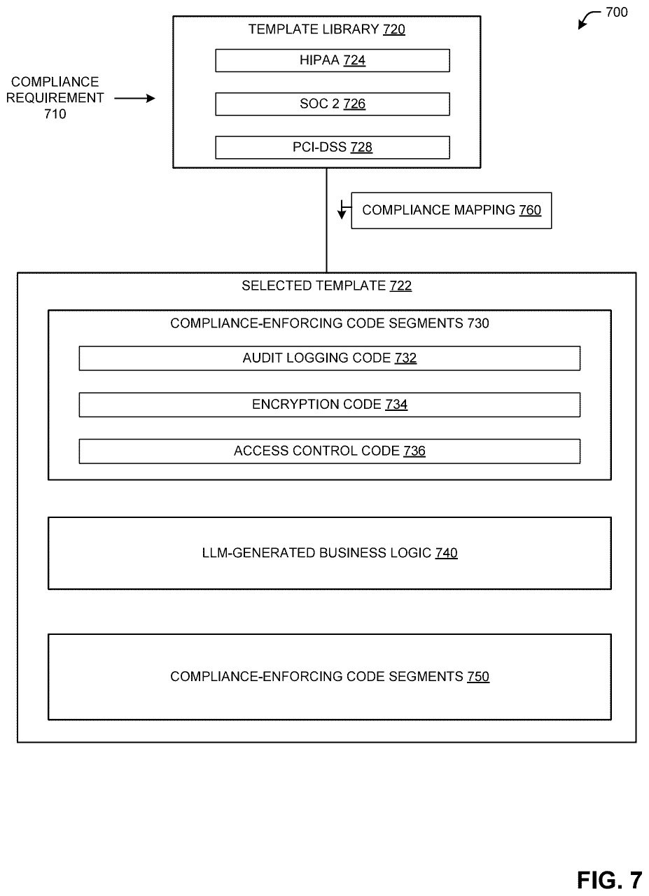

At block 220, the configuration agent 110 may select a code template from the template library 120 based on an execution pattern identified in the workflow specification 106. In one example, the workflow specification 106 may explicitly identify an execution pattern such as “simple,” “streaming,” “validator,” or “batch,” and the configuration agent 110 may retrieve the corresponding template. In another example, the configuration agent 110 may infer the execution pattern from characteristics of the workflow specification 106. For example, a workflow specification that defines a single input-output transformation with no intermediate stages may be mapped to a SimpleAgent template, while a workflow specification that defines a sequence of data processing steps with intermediate validation may be mapped to a ValidatorAgent template. When the workflow specification 106 specifies one or more compliance requirements, the configuration agent 110 may further constrain the template selection to templates that encode the required compliance frameworks, as described with reference to FIG. 7. In some examples, if multiple templates match the workflow specification 106, the configuration agent 110 may select the template that most closely matches the workflow characteristics according to a scoring function that considers factors such as the number of supported modules, the granularity of the bounded insertion region, and the coverage of applicable compliance requirements.

At block 230, the configuration agent 110 may select modules from the module library 130 based on capabilities indicated by the workflow specification 106. In one example, the configuration agent 110 may identify capability requirements by parsing the workflow specification 106 for references to data sources, integration endpoints, and communication channels. For example, a workflow specification that references a database connection string may trigger selection of a DatabaseModule, while a workflow specification that references an external API endpoint may trigger selection of an HTTPModule. In some examples, the configuration agent 110 may select multiple modules for a single workflow, and the selected modules may be composed such that the generated code may invoke functions from any of the selected modules. In other examples, the configuration agent 110 may verify that the selected modules are compatible with the selected template before proceeding to the next block.

At block 240, the configuration agent 110 may select prompt blocks from the prompt block library 140 based on compliance requirements and domain constraints specified in the workflow specification 106. In one example, the configuration agent 110 may select one prompt block per compliance requirement and one or more prompt blocks for domain-specific constraints. The selected prompt blocks may include regulatory constraint blocks that specify data handling requirements, output format blocks that specify the expected structure and format of the generated code's output, domain logic blocks that encode business rules specific to the workflow's application area, and security constraint blocks that specify access control and authentication requirements. In some examples, the configuration agent 110 may resolve ordering dependencies among prompt blocks such that blocks with prerequisite information may precede blocks that depend on that information.

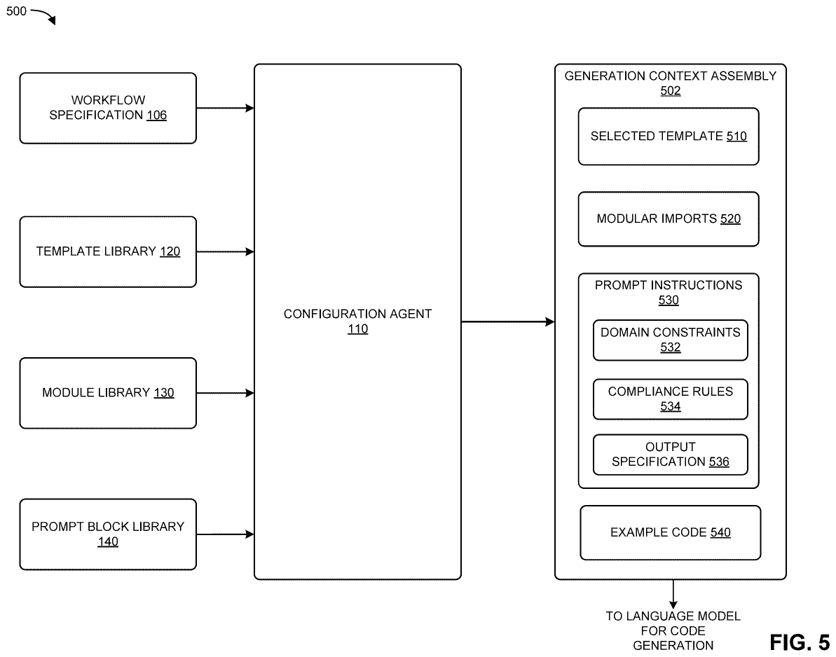

At block 250, the configuration agent 110 may assemble a generation context comprising the selected template, modules, and prompt blocks. This assembly process is described further with reference to FIG. 5. The generation context may define the bounded insertion region within which the language model may generate code, the module interfaces specifying the functions available to the generated code, and the prompt instructions constraining the generated code's behavior. In some examples, the configuration agent 110 may evaluate the size of the assembled generation context against the token limit of the target language model. If the generation context exceeds the token limit, the configuration agent 110 may truncate lower-priority prompt blocks, may summarize module interfaces to include function signatures without full documentation, or may select a language model with a larger context window. In other examples, the configuration agent 110 may include in the generation context one or more example code snippets drawn from previously generated and validated artifacts for similar workflow specifications, providing few-shot examples that may guide the language model toward producing code consistent with the system's conventions.

A generation loop 255 may encompass the iterative generation and validation cycle. At block 260, the system may invoke the language model with the generation context. The language model may generate code within the bounded insertion region. In one example, the generated code may comprise 20 to 50 lines of business logic implementing a process function, while the template may provide surrounding infrastructure code including initialization, error handling, and integration points. In some examples, the language model may generate the business logic within the bounded insertion region and may not generate or modify the fixed template regions. The language model interface 150 may enforce this constraint by instructing the language model to produce only the code within designated boundary markers. In other examples, the language model interface 150 may post-process the language model's output to extract only the code within the boundary markers and may discard any extraneous content.

In one example, the language model may return its output as raw text, and the language model interface 150 may parse the output to extract the generated code. The parser may identify the boundary markers (for example, “#---BEGIN GENERATED CODE---” and “#---END GENERATED CODE---”) in the language model's output and may extract the text between them. Content outside the boundary markers, including any preamble, explanation, or commentary produced by the language model, may be discarded. If the boundary markers are not found in the output, the language model interface 150 may treat the entire output as the generated code, or may treat the absence of markers as a generation failure and may retry. In another example, the language model interface 150 may request structured output from the language model, for example by instructing the language model to return a JSON object with a designated field containing the generated code. The language model interface 150 may then parse the JSON response and may extract the code field, avoiding the need for marker-based parsing. In yet another example, the language model interface 150 may employ a structured agent orchestration framework such as PydanticAI that defines typed response schemas, enabling the language model to return structured objects that may be automatically validated against the schema by the framework before the generated code is extracted and passed to the validation pipeline 160. Structured output approaches may reduce parsing errors and may provide an additional layer of format validation before the generated code enters the validation pipeline.

In some examples, the code generation system 102 may employ a structured agent orchestration framework to manage interactions with the language model. In one example, the system may employ a framework that defines typed input and output schemas for language model interactions, such that the language model's response may be automatically parsed into a structured object with typed fields rather than returned as unstructured text. The structured agent framework may validate the language model's response against the output schema before the response is passed to downstream processing, providing an early check on response format independent of the validation pipeline 160. In some examples, the structured agent framework may manage conversation state for multi-turn interactions with the language model, for example during regeneration where the system provides error context and requests revised code. The structured agent framework may maintain the conversation history comprising the original generation context, the generated code from each attempt, and the error context from each validation failure, enabling the language model to access the full history of the regeneration cycle when generating revised code. In other examples, the system may interact with the language model through a direct API call without an intermediary agent framework, constructing prompts and parsing responses programmatically.

At decision block 270, the validation pipeline 160 may evaluate the generated code by executing a plurality of validation stages in sequence, as described with reference to FIG. 3. If all validation stages pass, the flow may proceed to block 280 where the system may deploy a validated code artifact. In one example, deploying the validated code artifact may comprise storing the validated code artifact 164 in the artifact repository 170 and making it available for execution. In some examples, deployment may further comprise registering the artifact with a workflow execution engine, updating a routing table that maps workflow specification identifiers to artifact versions, or notifying the client 104 that the artifact is ready for execution.

If validation fails at one or more stages, the flow may proceed to block 290 where the system may generate error context identifying the failed validation stage. The error context may comprise a stage identifier indicating which validation stage failed, diagnostic information specific to the failure such as a line number, error message, or failing test case identifier, and optionally a suggested fix pattern indicating the type of remediation expected. The error context may be structured to provide the language model with actionable information for targeted regeneration. For example, an error context indicating a security validation failure due to a hardcoded credential at a specific line may enable the language model to focus on replacing the hardcoded credential with a reference to a secure credential store, rather than re-examining the entire generated code for all possible failure modes.

At decision block 285, the system may evaluate whether a retry threshold has been exceeded. The retry threshold may be a configurable parameter, for example three or five regeneration attempts. In one example, the retry threshold may be set per workflow specification, allowing more complex workflows to receive additional regeneration attempts. In another example, the retry threshold may be adjusted dynamically based on the type of validation failure, permitting more retries for accuracy failures that are likely to converge and fewer retries for security failures that may indicate a fundamental incompatibility between the workflow specification and the language model's capabilities.

If the retry threshold has not been exceeded, the flow may return to block 260 where the system may provide the error context to the language model for regeneration. In one example, the regeneration invocation may include both the original generation context and the error context, enabling the language model to understand what it generated previously and what went wrong. In some examples, the system may augment the regeneration context with the generated code from the failed attempt, annotated with the specific lines and error messages identified by the validation pipeline, so that the language model may see precisely what to fix. In other examples, the system may include error context from multiple prior failed attempts if the current attempt is a second or subsequent regeneration, providing the language model with a history of what has been tried and what has failed, enabling it to avoid repeating the same errors.

If the retry threshold has been exceeded, the flow may proceed to block 295 where the system may escalate the code for human review rather than continuing automated regeneration. In one example, escalation may comprise routing the workflow specification 106, the most recent generated code, and the accumulated error context history to a human review queue. The human reviewer may examine the error progression across regeneration attempts, may identify why the language model was unable to converge on valid code, and may take corrective action such as modifying the workflow specification, adjusting prompt blocks, updating the template, or manually editing the generated code. In some examples, actions taken by the human reviewer may be captured and fed back into the system to improve future generation. For example, manual code edits may be added to the example code library used in generation context assembly, and modifications to prompt blocks may be incorporated into the prompt block library 140 for use in future workflows.

FIG. 3 illustrates a block diagram of a validation pipeline, in accordance with example embodiments of the disclosure. The validation pipeline 300 may comprise a plurality of validation stages executed in sequence: a security validation stage 310, a syntax validation stage 320, an execution validation stage 330, and an accuracy validation stage 340. Each validation stage may evaluate the generated code against criteria specific to that validation stage and may output a result indicating pass or fail.

The validation stages may be ordered such that less computationally expensive stages may precede more computationally expensive stages. The security validation stage 310 and the syntax validation stage 320 may operate by static analysis of the code text without executing the code, and therefore may consume fewer computational resources and may complete more quickly than the execution validation stage 330, which may require instantiating a sandboxed runtime environment, or the accuracy validation stage 340, which may require executing the code against test data and comparing outputs. By ordering the stages in this manner, the validation pipeline 300 may avoid incurring the cost of sandboxed execution and accuracy testing for code that would fail on basic security or syntax criteria. In some examples, the ordering of validation stages may be configurable, and additional validation stages may be inserted into the pipeline without modifying existing stages. For example, a compliance-specific validation stage may be inserted between the syntax validation stage 320 and the execution validation stage 330 to verify that the generated code conforms to structural compliance requirements before executing it.

The security validation stage 310 may evaluate the generated code against security criteria. In one example, the security validation stage 310 may perform static analysis of the generated code to detect unsafe code patterns. The security criteria may include detection of injection vulnerabilities such as SQL injection, command injection, and path traversal; detection of hardcoded credentials such as API keys, passwords, and tokens embedded in the code text; detection of unauthorized network access attempts such as connections to endpoints not specified in the workflow specification; and detection of file system operations outside permitted directories. In one example, the security validation stage 310 may employ pattern-matching rules that scan the abstract syntax tree of the generated code for known unsafe constructs. In another example, the security validation stage 310 may employ a rule engine that evaluates the generated code against a configurable set of security rules, where rules may be added, removed, or modified without changing the validation stage implementation. In yet another example, the security validation stage 310 may employ taint analysis to trace data flow from untrusted inputs through the generated code and may flag any path where untrusted data reaches a sensitive operation such as a database query or system command without intervening sanitization. In one example, the security validation stage 310 may employ static analysis tools such as Bandit for detecting common security issues in Python code and Semgrep for pattern-based detection of security vulnerabilities using configurable rule sets, along with custom security rules specific to the template architecture. In other examples, the security validation stage 310 may employ other static analysis tools appropriate to the programming language of the generated code. The security validation stage 310 may output a security validation result indicating pass or fail. Upon failure, the security validation stage 310 may generate diagnostic information comprising the specific security rule that was violated, the line number or code region where the violation was detected, and a description of the vulnerability.

Upon the security validation result indicating pass, the pipeline may proceed to the syntax validation stage 320. The syntax validation stage 320 may evaluate the generated code against syntactic and semantic criteria. In one example, the syntax validation stage 320 may parse the code into an abstract syntax tree and may verify that the tree is well-formed. In one example, the syntax validation stage 320 may employ type checking tools such as mypy for verifying type correctness of the generated code and linting tools such as ruff for enforcing code style conventions and detecting common programming errors. In other examples, the syntax validation stage 320 may employ other type checking and linting tools appropriate to the programming language of the generated code. The syntax validation stage 320 may further verify type correctness by analyzing function calls, variable assignments, and return types to confirm that types are consistent throughout the generated code. The syntax validation stage 320 may also confirm that all referenced identifiers are defined, meaning that every variable, function, and module reference in the generated code may correspond to a definition either in the generated code itself or in the module interfaces provided through the template. In some examples, the syntax validation stage 320 may additionally apply linting rules that enforce code style conventions, naming conventions, and structural patterns consistent with the template architecture. In one example, the syntax validation stage 320 may verify that the generated code does not import modules beyond those made available by the template and selected modules, preventing the generated code from introducing unauthorized dependencies. The syntax validation stage 320 may output a syntax validation result indicating pass or fail. Upon failure, the syntax validation stage 320 may generate diagnostic information comprising the type of syntax or semantic error, the line number and column position of the error, and the expected versus actual construct.

Upon the syntax validation result indicating pass, the pipeline may proceed to the execution validation stage 330. The execution validation stage 330 may execute the generated code in a sandboxed environment. In one example, the sandboxed environment may comprise resource limits on memory consumption, CPU time, and network access. The resource limits may prevent the generated code from consuming unbounded resources, which may occur if the language model generates code containing infinite loops, recursive calls without termination conditions, or excessive memory allocation. In one example, the sandboxed environment may impose a memory limit of a configurable amount such as 256 megabytes, a CPU time limit of a configurable duration such as 30 seconds, and a network access policy that permits connections only to endpoints specified in the workflow specification. In some examples, the sandboxed environment may comprise a containerized execution environment that isolates the generated code from the host system, preventing file system access, process spawning, or other operations that may affect system state outside the sandbox. The execution validation stage 330 may execute the generated code against a set of test inputs. In one example, the test inputs may be derived from test fixtures defined in the workflow specification. In another example, the test inputs may be drawn from a library of standard test inputs associated with the selected template. The execution validation stage 330 may monitor for runtime exceptions, infinite loops, timeout conditions, and resource limit violations. The execution validation stage 330 may output an execution validation result indicating pass or fail. Upon failure, the execution validation stage 330 may generate diagnostic information comprising the exception type and message, the stack trace identifying the line of code where the exception occurred, and the resource consumption at the time of failure.

Upon the execution validation result indicating pass, the pipeline may proceed to the accuracy validation stage 340. The accuracy validation stage 340 may compare outputs of the generated code against reference data. In one example, the reference data may comprise golden outputs, which may be pre-computed correct outputs for a set of test inputs defined in the workflow specification. The accuracy validation stage 340 may execute the generated code against each test input and may compare the produced output against the corresponding golden output. The comparison may be exact, requiring identical output, or may allow tolerances defined in the workflow specification. For example, a numeric output may be required to match the golden output within a specified percentage, or a text classification output may be required to match a set of acceptable labels. In some examples, the accuracy validation stage 340 may compute an accuracy score representing the proportion of test inputs for which the generated code produces correct output, and the stage may pass only if the accuracy score meets or exceeds a threshold defined in the workflow specification. In other examples, the accuracy validation stage 340 may evaluate additional quality metrics beyond correctness, such as output format conformance, response completeness, or consistency across repeated executions with the same input. The accuracy validation stage 340 may output an accuracy validation result indicating pass or fail. Upon failure, the accuracy validation stage 340 may generate diagnostic information comprising the test input that produced incorrect output, the expected output, the actual output, and the delta or difference between expected and actual.

Upon all validation stages passing, the pipeline may output a validated code artifact 350. The validated code artifact 350 may comprise the generated code, assembled with its template and module dependencies, that has passed all validation stages and may be ready for deployment to the artifact repository 170.

Upon any validation stage outputting a result indicating fail, an error context generator 355 may generate error context identifying the failed validation stage. The error context may comprise a stage identifier indicating which of the plurality of validation stages failed. The stage identifier may provide categorical information that may enable the language model to focus its regeneration effort on the relevant failure mode. For example, a stage identifier indicating “security validation” may direct the language model to examine security-related aspects of the code, while a stage identifier indicating “accuracy validation” may direct the language model to examine the logic and correctness of the code's output. In one example, the error context may further comprise diagnostic information specific to the failed stage, such as a line number, an error message, a failing test case identifier, or a suggested fix pattern. The suggested fix pattern may comprise a high-level indication of the type of remediation expected, such as “add input sanitization before database query” or “handle missing key in input dictionary.” In some examples, the error context generator 355 may produce different levels of detail depending on the stage that failed. For example, the error context for a security validation failure may include the specific security rule violated and a reference to the relevant security standard, while the error context for an execution validation failure may include the full stack trace and the test input that triggered the exception. In some examples, the error context generator 355 may aggregate error information from all stages that the generated code has been evaluated against, not only the first failing stage. This aggregated error context may enable the language model to address multiple issues in a single regeneration attempt, reducing the total number of regeneration cycles.

A regeneration counter 360 may track the number of regeneration attempts for a given workflow specification. The regeneration counter 360 may be incremented each time the language model is invoked for regeneration. An escalation module 370 may evaluate whether the regeneration counter 360 has exceeded a threshold. If the threshold has not been exceeded, the error context may be provided to the language model for regeneration 375, and the validation pipeline may re-execute all stages on the newly generated code. Re-executing all stages, rather than resuming from the failed stage, may be configured such that a regeneration attempt that fixes one issue may not have introduced a new issue in an earlier stage. If the regeneration counter 360 exceeds the threshold, the escalation module 370 may escalate the code for human review 380 rather than continuing automated regeneration. In one example, the escalation module 370 may package the workflow specification, the most recent generated code, and the error context history from all regeneration attempts into a review package that may be routed to a human review queue. The error context history may enable the human reviewer to see the progression of failures across regeneration attempts and may identify whether the language model is making progress toward valid code or is cycling between different failure modes.

In another example, the validation pipeline 300 may regenerate code at each validation stage before proceeding to the next stage rather than re-executing all stages from the beginning upon failure. In this example, the validation pipeline 300 may execute the security validation stage 310 and, upon failure, may generate error context and may provide it to the language model for regeneration before proceeding to the syntax validation stage 320. The language model may regenerate the code, the system may reassemble the code artifact, and the validation pipeline may proceed to the syntax validation stage 320 on the reassembled artifact. If the syntax validation stage 320 fails, the pipeline may again generate error context, may regenerate, may reassemble, and may proceed to the execution validation stage 330. This per-stage inline regeneration may continue through each validation stage in sequence, such that by the time the pipeline reaches the accuracy validation stage 340, the code may have already been corrected for any security, syntax, and execution failures encountered in earlier stages. A regeneration counter may track total regeneration attempts across all stages and may escalate for human review upon exceeding a threshold. This inline approach may reduce the total number of full-pipeline re-executions by addressing each failure category in turn, though it may not detect regressions introduced during regeneration at a later stage that affect an earlier stage's criteria. In some examples, the system may select between the re-execute-all-stages approach described above and the per-stage inline regeneration approach based on workflow complexity, historical regeneration patterns, or a configurable policy.

FIG. 4 illustrates a schematic diagram of a template structure, in accordance with example embodiments of the disclosure. The code template 400 may comprise a header region 410, a bounded insertion region 420, and a footer region 430. The template structure may enforce a separation between fixed infrastructure code authored by developers and generated business logic produced by the language model. This separation may be configured such that critical infrastructure code, including compliance-enforcing code, is not subject to the variability inherent in language model generation.

The header region 410 may comprise fixed code that may execute prior to the generated business logic. In one example, the header region 410 may include import statements 412, initialization code 414, and compliance hooks 416. The import statements 412 may import the modules selected by the configuration agent, making their interfaces available to the generated business logic. In one example, the import statements 412 may be populated by the configuration agent based on the modules selected for the workflow, so that only the required module interfaces may be present in the final code artifact. The initialization code 414 may perform setup operations such as establishing database connections, initializing HTTP client sessions, configuring logging handlers, and setting up error handling middleware. In some examples, the initialization code 414 may be parameterized by values from the workflow specification 106, such as database connection strings, API endpoint URLs, and timeout values. The compliance hooks 416 may comprise code that may enforce compliance requirements. For example, a HIPAA compliance hook may initialize audit logging that records every data access event with a timestamp, user identifier, and data category accessed. A SOC 2 compliance hook may initialize encryption for all data at rest and may enforce TLS for all data in transit. A PCI-DSS compliance hook may initialize tokenization of payment card numbers and may enforce access control checks before any card data is accessed. Because the compliance hooks 416 may be in the fixed header region 410 and may execute prior to any generated business logic, they may not be dependent on the language model generating compliant code. The header region 410 may not be modified by the language model during code generation.

The bounded insertion region 420 may comprise a designated area within the code template 400 where the language model may generate code. The bounded insertion region 420 may be demarcated by a boundary marker 422 at the start and a boundary marker 426 at the end that may define the extent of the region. In one example, the boundary markers 422 and 426 may comprise code comments with distinctive identifiers, such as “#---BEGIN GENERATED CODE---” and “#---END GENERATED CODE---”, that may be recognizable by both the language model and the validation pipeline. In another example, the boundary markers may comprise function definition signatures that the generated code must implement, such as “def process(input_data: InputSchema)->OutputSchema:”, where the generated code may provide the function body. In yet another example, the boundary markers may comprise structural delimiters in the code file that may be parsed programmatically during assembly and validation. Within the bounded insertion region 420, the language model may generate LLM-generated business logic 424. The LLM-generated business logic 424 may be constrained to implement a defined interface such as a process function accepting specified input parameters and returning specified output types. In one example, the LLM-generated business logic 424 may comprise 20 to 50 lines of code implementing decision logic, data transformations, or business rules. The generated code may call functions exposed by the module interfaces imported in the header region 410, but may not import additional modules, may not access the file system directly, or may not perform operations outside the capabilities exposed through the template. In some examples, the validation pipeline may verify this constraint during the syntax validation stage by checking that no import statements or function definitions appear in the generated code that are not present in the template's module interface definitions.

The system may enforce the bounded insertion region 420 through multiple mechanisms. At generation time, the language model interface 150 may instruct the language model to produce code only within the boundary markers and may include the boundary markers in the prompt so that the model may understand the insertion boundary. At assembly time, the system may extract only the code between the boundary markers from the language model's output and may discard any content outside the markers. At validation time, the syntax validation stage may verify that the generated code does not contain constructs that would allow it to affect execution outside the bounded insertion region, such as modifying global state, overwriting template functions, or monkey-patching module interfaces. These layered enforcement mechanisms may be configured such that the language model's output may be contained within the bounded insertion region regardless of what the model produces.

In some examples, the bounded insertion region may be enforced such that the generated code does not modify state outside the insertion region. At generation time, the language model interface may instruct the language model to generate code only within the boundary markers, and the language model may produce code confined to the designated insertion area. At assembly time, the system may extract the code between the boundary markers from the language model's output and may discard any content outside the boundary markers, including any preamble, commentary, or code that the language model may have produced beyond the designated area. At validation time, the syntax validation stage may verify that the generated code does not contain constructs that would modify state outside the insertion region, such as import statements not present in the template's module interface definitions, assignments to variables defined in the fixed template regions, modifications to global state, overwriting of template functions, or monkey-patching of module interfaces. This three-layer enforcement across generation, assembly, and validation may be configured such that the generated code operates within the bounded insertion region without affecting the execution of the compliance-enforcing code segments in the fixed header and footer regions.

The footer region 430 may comprise fixed code that may execute after the generated business logic. In one example, the footer region 430 may include post-processing logic 432, cleanup code 434, and return statement 436. The post-processing logic 432 may comprise output formatting, data transformation, or result aggregation that may standardize the output of the generated business logic into a format expected by downstream consumers. The cleanup code 434 may comprise resource release operations such as closing database connections, terminating HTTP sessions, and flushing log buffers. The return statement 436 may return the processed output from the code artifact. In some examples, the footer region 430 may include additional compliance-enforcing code such as audit logging of the business logic results, encryption of output data before transmission, and verification that the output conforms to regulatory requirements before it is returned. The footer region 430 may not be modified by the language model during code generation.

The header region 410 and footer region 430 together may comprise compliance-enforcing code segments that encode compliance requirements. Because the language model may generate code only within the bounded insertion region 420, and because the bounded insertion region 420 may be surrounded by the compliance-enforcing code segments, the generated code may inherit compliance properties from the template structure. This structural containment may be configured such that compliance requirements may be satisfied without requiring the language model to generate compliant code directly. For example, even if the language model generates business logic that does not explicitly log data access events, the audit logging in the header region 410 and footer region 430 may be performed such that all data access may be logged. This structural approach may provide a compliance property that need not depend on the language model's awareness of or compliance with regulatory requirements.

In some examples, templates may be versioned and stored in the template library 120 with metadata describing the compliance frameworks they encode, the execution patterns they support, and the module interfaces they expect. New templates may be authored by developers to support additional compliance frameworks or execution patterns, and may be added to the template library 120 without modifying the configuration agent 110, the language model interface 150, or the validation pipeline 160. In some examples, templates may be composed from reusable fragments, such that a compliance header fragment encoding HIPAA requirements may be combined with a compliance header fragment encoding SOC 2 requirements to produce a hybrid template encoding both frameworks.

FIG. 5 illustrates a block diagram of generation context assembly, in accordance with example embodiments of the disclosure. The diagram 500 may show a generation context assembly 502 performed by the configuration agent 110 from components selected based on the workflow specification 106.

The configuration agent 110 may receive the workflow specification 106 and may retrieve components from the template library 120, the module library 130, and the prompt block library 140. The configuration agent 110 may select a template from the template library 120 based on an execution pattern identified in the workflow specification 106, modules from the module library 130 based on capabilities indicated by the workflow specification 106, and prompt blocks from the prompt block library 140 based on compliance requirements and domain constraints.

The generation context assembly 502 may produce a structured generation context comprising a selected template 510, modular imports 520, prompt instructions 530, and example code 540.

The selected template 510 may define the code structure including the bounded insertion region. The selected template 510 may be provided to the language model as part of the generation context so that the language model may see the header region, the boundary markers demarcating the insertion region, and the footer region. By including the full template in the generation context, the language model may generate business logic that is consistent with the initialization performed in the header region and the post-processing expected in the footer region. For example, if the header region initializes a database connection object named “db,” the language model may reference “db” in the generated business logic to execute queries. In some examples, the selected template 510 may be provided to the language model in an annotated form that includes comments describing the purpose of each template region, the available interfaces, and the expected behavior of the generated code within the insertion region.

The modular imports 520 may define the functions and parameters available to the generated code from the selected modules. In one example, the modular imports 520 may comprise function signatures, parameter types, return types, and brief descriptions of each function's behavior. For example, a DatabaseModule import may expose functions such as “query(sql: str, params: dict)->list[dict]” for executing parameterized queries and “transaction(callback: callable)->bool” for executing operations within a database transaction. An HTTPModule import may expose functions such as “get(url: str, headers: dict)->Response” and “post(url: str, body: dict)->Response” for making external API calls. By providing module interfaces as function signatures rather than full implementation code, the generation context may convey the available capabilities to the language model without consuming excessive context window space. In some examples, the modular imports 520 may further include usage constraints, such as indicating that the database query function requires parameterized queries and will reject raw string concatenation, or that the HTTP module enforces TLS and will reject plaintext HTTP endpoints. These usage constraints may guide the language model toward generating code that conforms to the modules' security and correctness requirements.

The prompt instructions 530 may comprise domain constraints 532 describing business rules, compliance rules 534 describing regulatory requirements, and output specifications 536 describing expected behavior.

The domain constraints 532 may encode business rules specific to the workflow's application area. For example, domain constraints for a healthcare prior authorization workflow may specify that authorization decisions must consider patient eligibility, coverage terms, and medical necessity criteria. Domain constraints for a financial transaction workflow may specify that transactions above a threshold amount require additional approval. In some examples, the domain constraints 532 may be expressed in natural language and may be included in the prompt to instruct the language model on the business logic to implement within the bounded insertion region.

The compliance rules 534 may encode regulatory requirements that constrain the generated code's behavior. For example, HIPAA compliance rules may specify that the generated code must apply minimum necessary access principles and must not log protected health information in plaintext. SOC 2 compliance rules may specify that the generated code must validate all external inputs and must not disable security controls. In some examples, the compliance rules 534 may complement the structural compliance enforcement provided by the template's compliance hooks 416, providing a defense-in-depth approach where the template may structurally enforce compliance through fixed code and the prompt may additionally instruct the language model to generate compliant business logic. This dual enforcement may reduce the probability of compliance violations even if one enforcement mechanism is insufficient on its own.

The output specifications 536 may describe the expected structure and content of the generated code's output. For example, the output specifications 536 may specify that the output must be a JSON object with specific required fields, that numeric values must be within specified ranges, or that classification labels must be drawn from a defined set of acceptable values. The output specifications 536 may enable the accuracy validation stage 340 to evaluate the generated code's output against defined criteria.

In one example, the generation context assembly 502 may further include example code 540 demonstrating expected patterns for similar workflow implementations. The example code 540 may comprise one or more code snippets drawn from previously generated and validated artifacts for similar workflow specifications. By providing examples of code that has been successfully validated, the generation context may guide the language model toward producing code that follows established patterns and conventions. In some examples, the example code 540 may be selected by the configuration agent 110 based on similarity between the current workflow specification and the workflow specifications associated with previously generated artifacts. Similarity may be measured by comparing workflow parameters, module selections, compliance requirements, or domain characteristics. In other examples, the example code 540 may be hand-authored by developers and stored in the prompt block library 140 as example prompt blocks that may be selected along with other prompt blocks during generation context assembly.

The output of the generation context assembly 502 may be the generation context 112, which may be transmitted to the language model for code generation within the bounded insertion region of the selected template 510. In some examples, the configuration agent 110 may evaluate the total size of the generation context 112 against the context window limit of the target language model before transmission. If the generation context 112 exceeds the context window limit, the configuration agent 110 may apply reduction strategies such as summarizing module interfaces to include only function signatures without full documentation, truncating or omitting lower-priority prompt blocks, reducing the number of example code snippets, or selecting a language model with a larger context window. In some examples, the configuration agent 110 may prioritize the components of the generation context 112 according to their importance to generation quality: the selected template 510 and compliance rules 534 may be typically highest priority because they may define the structural constraints and regulatory requirements, while example code 540 may be typically lowest priority because its absence may reduce but may not eliminate generation quality.

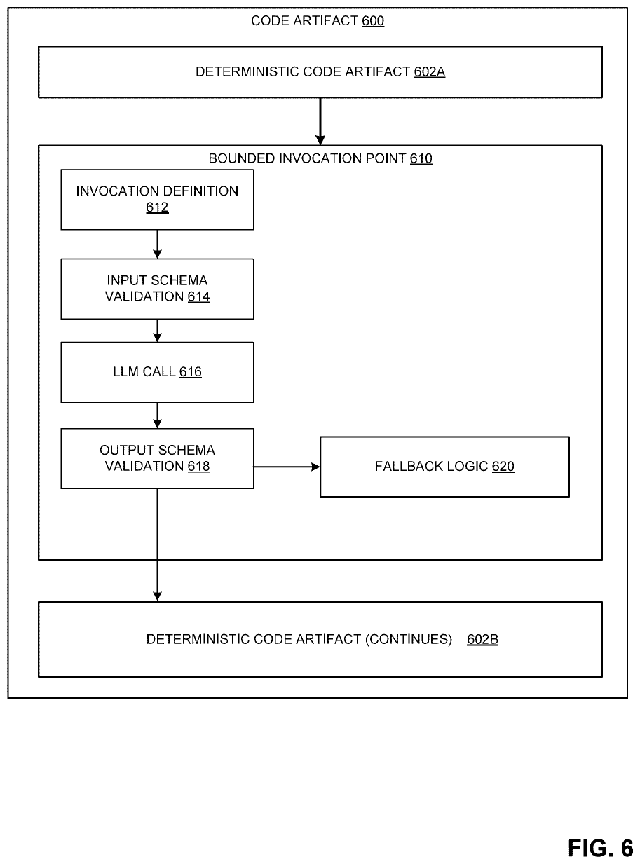

FIG. 6 illustrates a schematic diagram of bounded runtime invocation, in accordance with example embodiments of the disclosure. A code artifact 600 generated and validated by the system may include deterministic code artifact 602A, one or more bounded invocation points 610, and deterministic code artifact 602B that may continue after the invocation point.

The code artifact 600 may represent a complete, validated workflow that may execute deterministically except at defined invocation points. The distinction between the deterministic code artifact 602A, 602B and the bounded invocation points 610 may reflect a fundamental architectural decision: most workflow logic, including input validation, database queries, data transformations, business rule application, and output formatting, may be fully determined at generation time and may be executed without runtime language model involvement. However, certain subtasks may require judgment that may not be fully determined at generation time, such as classifying ambiguous inputs, extracting information from unstructured text, or generating natural language summaries. The bounded invocation points 610 may enable the code artifact 600 to delegate these judgment-requiring subtasks to a language model at runtime while containing the non-determinism inherent in language model output within observable and controllable boundaries.

The deterministic code artifact 602A may execute prior to the bounded invocation point 610. In various examples, the deterministic code artifact 602A may comprise operations such as retrieving data from a database, validating input against business rules, preparing and structuring data for the language model subtask, and establishing any context required by the invocation point. Because the deterministic code artifact 602A may have been generated and validated through the validation pipeline 160, it may execute with the same predictability and compliance properties as any other validated code artifact.

Each bounded invocation point 610 may comprise an invocation definition 612, input schema validation 614, an LLM call 616, output schema validation 618, and fallback logic 620.

The invocation definition 612 may specify the subtask to be performed by the language model at runtime. In one example, the subtask may comprise one of classification, extraction, or summarization. In other examples, the subtask may comprise sentiment analysis, entity recognition, question answering, translation, or another natural language processing task that benefits from language model judgment. The invocation definition 612 may further specify the language model endpoint and any model-specific parameters such as temperature, maximum output tokens, and system prompt. In some examples, the invocation definition 612 may specify a timeout duration for the language model call, after which the system may treat the call as failed and may execute the fallback logic 620. In some examples, the invocation definition 612 may specify a preferred language model and one or more fallback models, enabling the system to route the subtask to an alternative model if the preferred model is unavailable or returns an error. Because the invocation definition 612 may be embedded in the validated code artifact, it may not be modified at runtime, such that the subtask scope, model parameters, and timeout constraints may remain as defined during generation and validation.

The input schema validation 614 may define the structure of input transmitted to the language model at the invocation point 610 and may validate input prior to the LLM call 616. In one example, the input schema validation 614 may specify required fields, expected data types, and acceptable value ranges for input data. For example, an input schema for a medical records summarization invocation point may specify that the input must include a patient identifier of string type, a list of medical events where each event includes a date, a diagnosis code, and a description, and a maximum summary length of integer type between 50 and 500 words. The system may validate input against the input schema validation 614 prior to transmitting input to the language model, rejecting malformed requests before incurring inference cost. This pre-validation may serve two purposes: it may prevent malformed or adversarial input from reaching the language model, and it may avoid the latency and cost of a language model invocation that would inevitably produce non-conforming output due to non-conforming input. In some examples, the input schema validation 614 may also apply data sanitization, such as removing personally identifiable information from fields that should not contain it, or truncating input fields that exceed maximum lengths, before transmitting the sanitized input to the language model.

The LLM call 616 may transmit the validated input to the language model and may receive output from the language model. In one example, the LLM call 616 may construct a prompt comprising the invocation definition's system prompt, the validated input formatted according to the invocation definition, and optionally one or more few-shot examples demonstrating the expected output format. In some examples, the LLM call 616 may record metadata about the invocation, including the language model used, the input token count, the output token count, the latency of the call, and the timestamp. This metadata may support operational monitoring and cost tracking at the invocation point level. In some examples, the LLM call 616 may implement a timeout mechanism that aborts the call if the language model does not respond within the duration specified in the invocation definition 612, treating the timeout as a validation failure that may trigger the fallback logic 620. In some examples, the timeout mechanism may abort the language model call regardless of whether the language model has produced partial output. If the language model has begun generating output but has not completed its response within the timeout duration, the system may discard the partial output and may execute the fallback logic as if no output had been received. In other examples, the system may evaluate partial output against the output schema before discarding it; if the partial output satisfies the output schema, the system may use the partial output rather than executing the fallback logic. The timeout duration may be configurable per invocation point, enabling different subtasks within the same code artifact to specify different timeout durations appropriate to their expected inference latency.

The output schema validation 618 may define the structure of output expected from the language model and may validate the received output. In one example, the output schema validation 618 may specify required fields, expected data types, and acceptable value patterns for output data. For example, an output schema for a classification invocation point may specify that the output must include a category field whose value is one of a defined set of acceptable labels, a confidence score of numeric type between 0 and 1, and optionally a reasoning field of string type. The output schema validation 618 may validate that all required fields are present, that field values conform to their specified types, that values fall within specified ranges or match specified patterns, and that no unexpected fields are present. Upon the output conforming to the output schema validation 618, the validated output may pass to the deterministic code artifact 602B for further processing. In some examples, the output schema validation 618 may apply normalization to conforming output, such as rounding numeric values to a specified precision or canonicalizing string values to a standard format, before passing the output to the deterministic code artifact 602B.

Upon output failing validation against the output schema validation 618, the system may execute the fallback logic 620. The fallback logic 620 may be configured to promote deterministic behavior even when language model output is non-conforming. In various examples, the fallback logic 620 may comprise one or more of: returning a default value, retrying with modified input, or routing to a human review queue. In one example, the fallback logic 620 may implement a cascade of fallback strategies that may be attempted in sequence. For example, the system may first retry the language model call with a modified prompt that more explicitly specifies the required output format. If the retry also produces non-conforming output, the system may return a predefined default value that is known to be safe and conforming, such as a “requires manual review” classification label. If neither retry nor default value is appropriate for the workflow, the system may route the request to a human review queue for manual processing. In some examples, the fallback logic 620 may be configurable per invocation point, enabling different invocation points within the same code artifact to implement different fallback strategies appropriate to their respective subtasks. For example, a classification invocation point may use a default category as its primary fallback, while a summarization invocation point may route to human review because a default summary would not be useful.

The deterministic code artifact 602B may execute after the bounded invocation point 610 and may comprise operations such as processing the invocation result, applying additional business rules based on the language model's output, updating database records, continuing the workflow with subsequent steps, and returning the final output. Because the output schema validation 618 and fallback logic 620 may be configured such that the bounded invocation point 610 may be expected to produce conforming output regardless of language model behavior, the deterministic code artifact 602B may safely assume that its input conforms to the expected schema. This configuration may reduce or eliminate the need for the deterministic code artifact 602B to implement defensive error handling for non-conforming language model output, simplifying the generated code and reducing the surface area for bugs.

The code artifact 600 may execute deterministically except at the bounded invocation points 610. Runtime language model calls may be contained within the invocation points 610 by the input schema validation 614, output schema validation 618, and fallback logic 620, such that non-deterministic language model behavior may not propagate beyond defined boundaries. In some examples, the system may monitor output distributions from bounded invocation points over time. If the distribution of language model outputs changes, for example if confidence scores that previously averaged 0.85 begin averaging 0.60, the system may detect this drift and may trigger regeneration of the code artifact to realign the workflow with current language model behavior. This drift monitoring may maintain workflow reliability as underlying language models are updated or replaced. In some examples, a code artifact 600 may include multiple bounded invocation points 610, each with its own invocation definition, schemas, and fallback logic, enabling workflows that require language model judgment at multiple stages to contain non-determinism at each stage independently.

In some examples, the system may monitor the output distribution from the bounded invocation point by maintaining a statistical summary of outputs over a sliding window of recent invocations. The statistical summary may comprise a distribution of confidence scores, a distribution of output categories or labels, or a distribution of output field values. The system may detect drift by comparing the statistical summary of recent outputs against a baseline distribution established during initial deployment or during a calibration period. In one example, the system may compute a divergence metric such as a threshold on the difference between the mean confidence score of recent outputs and the baseline mean. In another example, the system may detect a shift in the distribution of output categories, such as a category that previously represented a small percentage of outputs now representing a substantially larger percentage.

In some examples, the system may distinguish between gradual drift and sudden drift. Gradual drift may manifest as a slow change in the statistical summary over an extended period, which may indicate incremental changes in language model behavior due to model updates or data distribution shifts. Sudden drift may manifest as an abrupt change in the statistical summary, which may indicate a language model replacement or a significant change in input characteristics. The system may apply different regeneration policies for gradual drift and sudden drift. For gradual drift, the system may trigger regeneration when the divergence metric exceeds a first threshold over a longer observation window. For sudden drift, the system may trigger regeneration when the divergence metric exceeds a second, lower threshold over a shorter observation window, enabling faster response to abrupt behavioral changes.

FIG. 7 illustrates a schematic diagram of compliance encoding, in accordance with example embodiments of the disclosure. The compliance encoding 700 may show how compliance requirements may be structurally embedded in templates such that generated code may inherit compliance properties by structural containment rather than by reliance on the language model generating compliant code.

A compliance requirement 710 may specify a regulatory or policy constraint that generated code may need to satisfy. In one example, the compliance requirement 710 may comprise HIPAA requirements for healthcare data, SOC 2 requirements for security controls, or PCI-DSS requirements for payment card data. In other examples, the compliance requirement 710 may comprise GDPR requirements for personal data protection, CCPA requirements for consumer privacy, FERPA requirements for educational records, or organizational security policies that are not derived from external regulation. The compliance requirement 710 may be specified in the workflow specification 106 as one or more identifiers referencing defined compliance frameworks. In some examples, the workflow specification 106 may specify multiple compliance requirements, for example both HIPAA and SOC 2, requiring the system to select a template that satisfies all specified requirements.

A template library 720 may store templates indexed by compliance requirement. In one example, the template library 720 may include a HIPAA template 724 encoding healthcare data protections, a SOC 2 template 726 encoding security controls, and a PCI-DSS template 728 encoding payment card data protections. Each template in the template library 720 may encode its associated compliance requirements in the fixed code regions of the template, outside the bounded insertion region. The configuration agent may select a template from the template library 720 based on the compliance requirement 710 specified in the workflow specification. In some examples, the template library 720 may index templates by compliance requirement, enabling direct lookup. For example, a query for “HIPAA” may return the HIPAA template 724, and a query for “SOC 2” may return the SOC 2 template 726. In some examples, the template library 720 may support compound queries, enabling a query for “HIPAA and SOC 2” to return a template that encodes both compliance frameworks. Hybrid templates encoding multiple compliance frameworks may be pre-authored and stored in the template library 720, or may be composed at selection time by merging compliance-enforcing code segments from multiple single-framework templates.

A selected template 722 may encode the compliance requirement 710 in compliance-enforcing code segments. The selected template 722 may comprise compliance-enforcing code segments 730 positioned in a fixed header region, LLM-generated business logic 740 within the bounded insertion region, and compliance-enforcing code segments 750 positioned in a fixed footer region.

The compliance-enforcing code segments 730 in the header region may comprise audit logging code 732 that may record data access events, encryption code 734 that may encrypt sensitive data at rest and in transit, and access control code 736 that may enforce authorization requirements. In one example, the audit logging code 732 may initialize an audit logger that records every data access event with a timestamp, user or system identifier, data category accessed, and access type (read, write, or delete). The audit logging code 732 may be configured to write audit records to a tamper-resistant audit log store. The encryption code 734 may establish encrypted connections to databases and external services, and may initialize encryption keys for data that will be processed by the generated business logic. The access control code 736 may verify that the requesting user or system has authorization to perform the requested operation before any data is accessed or processed by the generated business logic. In some examples, the compliance-enforcing code segments 730 may include additional compliance measures such as data retention policy enforcement, consent verification, data minimization checks, or geographic data residency validation.

The compliance-enforcing code segments 750 in the footer region may comprise corresponding completion logic such as logging the outcome of the business logic execution, encrypting output data before returning it to the caller, verifying that no unencrypted sensitive data remains in memory or temporary storage, and closing audit log entries. In one example, the footer compliance-enforcing code segments 750 may perform a compliance validation check on the output of the generated business logic before the output is returned, verifying that the output does not contain unmasked sensitive data, that all required audit records have been written, and that encryption has been applied to all output fields designated as sensitive.

Because the compliance-enforcing code segments 730 and 750 may be in the fixed regions of the selected template 722, they may execute independent of the code generated by the language model in the bounded insertion region. The LLM-generated business logic 740 may inherit compliance properties by structural containment within the compliance-enforcing code segments. This structural containment may provide a stronger compliance property than approaches that rely on the language model to generate compliant code, because the compliance enforcement may not depend on the language model's awareness of regulatory requirements, its ability to implement those requirements correctly, or the completeness of the compliance instructions in the generation context. Even if the language model generates business logic that makes no attempt to comply with regulatory requirements, the template's structural containment may be configured such that audit logging, encryption, and access control may still be enforced.

A compliance mapping 760 may associate compliance requirements with templates in the template library 720, enabling the configuration agent to select a template satisfying compliance requirements specified in the workflow specification. In one example, the compliance mapping 760 may be a data structure that maps compliance requirement identifiers to template identifiers in the template library 720. In some examples, the compliance mapping 760 may include metadata describing the specific compliance controls encoded by each template, enabling the configuration agent to verify that a selected template covers all required controls. In some examples, hybrid approaches combining multiple compliance frameworks may be supported by selecting templates that encode multiple compliance requirements, or by composing compliance-enforcing code segments from multiple templates into a single hybrid template. The hybrid composition may involve concatenating header compliance segments from each framework, resolving any conflicts between frameworks (for example, if one framework requires logging a data field that another framework requires redacting), and concatenating footer compliance segments.

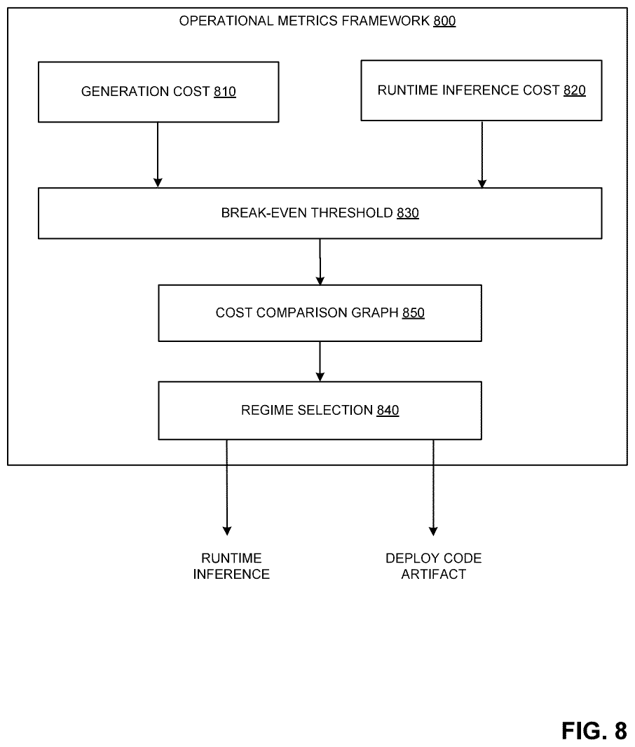

FIG. 8 illustrates a schematic diagram of an operational metrics framework, in accordance with example embodiments of the disclosure. The framework 800 may compute metrics for selecting between deploying a generated code artifact and executing a workflow by runtime language model inference. The operational metrics framework may enable per-workflow optimization of the generation-versus-inference tradeoff, allocating computational resources according to expected usage patterns rather than applying a uniform execution strategy across all workflows.

A generation cost component 810 may compute a generation cost Cg representing the cost of generating a code artifact by a language model from a workflow specification. In one example, the generation cost Cg may comprise token costs for language model invocations during generation, computational costs for validation pipeline execution, and token costs for any regeneration attempts. In some examples, the generation cost Cg may further include infrastructure costs such as compute time for sandboxed execution during the execution validation stage, storage costs for intermediate artifacts, and human review costs if the escalation module 370 is triggered and a human reviewer intervenes. The generation cost Cg may be a one-time upfront cost that may be incurred once per workflow specification and may be amortized across all subsequent executions of the resulting validated code artifact. In some examples, the generation cost component 810 may estimate the generation cost Cg prior to generation by analyzing the complexity of the workflow specification, the expected number of validation stages, and historical generation costs for similar workflow specifications, enabling the system to make an informed regime selection decision before incurring the generation cost.

A runtime inference cost component 820 may compute a runtime inference cost Cr representing the cost of executing a workflow specification by runtime language model inference for a single execution. In one example, the runtime inference cost Cr may comprise token costs for language model invocation, latency costs representing time value, and variability costs representing risk of non-deterministic output. The token costs may represent the direct monetary cost of transmitting the workflow specification and receiving the language model's output for each execution. The latency costs may represent the time required for the language model to process the request and generate output, which may be significant in latency-sensitive applications. The variability costs may represent the risk that the language model produces different outputs for the same input across repeated executions, which may cause inconsistent behavior in downstream systems, inconsistent audit trails, or inconsistent user experiences. In some examples, the runtime inference cost component 820 may compute the variability cost by measuring the variance of language model outputs across a sample of repeated invocations with identical input. Higher variance may increase the effective runtime inference cost Cr, shifting the break-even threshold toward favoring code artifact deployment. In some examples, the runtime inference cost Cr may further include the cost of any output validation and error handling that must be performed per execution when using runtime inference, including the cost of handling non-conforming outputs and the cost of retries.

A break-even threshold component 830 may compute a break-even threshold N representing the number of executions at which the generation cost equals cumulative runtime inference cost. The break-even threshold N may be computed as N=Cg/Cr. Below the break-even threshold, runtime inference may be more economical because the cumulative inference cost may not yet have exceeded the one-time generation cost. Above the break-even threshold, deploying the generated code artifact may be more economical because the generation cost may have been amortized across sufficient executions and the code artifact may execute without further language model invocation cost. In some examples, the break-even threshold component 830 may adjust the computation to account for the marginal runtime cost of deployed artifacts, which may be nonzero if the code artifact includes bounded invocation points 610 that incur language model inference costs at runtime. In such cases, the break-even threshold may be computed as N=Cg/(Cr−Cb), where Cb may represent the per-execution cost of bounded invocations in the deployed code artifact. Because Cb may be typically much less than Cr (bounded invocations may address narrow subtasks with small prompts, while runtime inference may process the entire workflow specification), the break-even threshold may remain finite and typically low for workflows with moderate execution frequency.

A regime selection component 840 may compare an expected number of executions to the break-even threshold N. Upon the expected number of executions exceeding the break-even threshold N, the regime selection component 840 may select deployment of the code artifact. Upon the expected number of executions being less than the break-even threshold N, the regime selection component 840 may select runtime language model inference. In some examples, the regime selection component 840 may apply a margin or confidence factor to the break-even threshold to account for uncertainty in the expected number of executions. For example, the regime selection component 840 may require the expected number of executions to exceed the break-even threshold by a configurable margin, such as 20%, before selecting artifact deployment, to avoid deploying artifacts for workflows that are near the break-even point and might not amortize their generation cost. In other examples, the regime selection component 840 may consider factors beyond cost, such as latency requirements, output consistency requirements, and compliance requirements, which may favor artifact deployment even below the break-even threshold. For example, a workflow with strict latency requirements may favor artifact deployment because deployed artifacts may execute without the latency of runtime language model inference, or a workflow with strict output consistency requirements may favor artifact deployment because deployed artifacts may produce deterministic outputs.

To illustrate the economic relationship, consider an example in which a generation cost Cg may total 50,000 tokens and a runtime inference cost Cr may be 500 tokens per execution. The break-even threshold N may be 100 executions (50,000/500). The cost comparison graph 850 may illustrate the economic relationship between the two execution modalities. A cumulative runtime inference cost curve may represent the cumulative cost of executing the workflow by runtime inference, increasing linearly with a slope of Cr as the number of executions increases. A code artifact cost line may represent the cost of the code artifact approach, equal to Cg at generation time and remaining flat thereafter because no additional language model invocations may be required. The two curves may intersect at the break-even threshold N, where the cumulative runtime inference cost may equal the one-time generation cost and beyond which artifact deployment may be more economical. For a workflow expected to execute 10,000 times per month, the expected execution count may substantially exceed the break-even threshold, favoring artifact deployment. For a workflow expected to execute four times per year, the expected execution count may fall below the break-even threshold, favoring runtime inference.

In another example, a generation cost Cg may total approximately 11,000 tokens and a runtime inference cost Cr may be approximately 500 tokens per execution. The break-even threshold N may be approximately 22 executions (11,000/500). At 1,000 executions, the deployed artifact approach may reduce total token consumption by approximately 45 times compared to runtime inference, because the deployed artifact may incur no additional token cost beyond the initial generation while runtime inference may incur 500 tokens per execution.

In one example, the operational metrics framework may further consider an output variability measure representing variation in outputs across repeated executions by runtime language model inference. Higher output variability may increase the effective cost Cr by introducing risk, shifting the break-even threshold toward favoring code artifact deployment. In some examples, the output variability measure may be computed by executing the workflow specification by runtime inference against a sample of test inputs and measuring the variance of the outputs across repeated executions. The variance may be measured as the proportion of test inputs for which repeated executions produce different outputs, or as a numerical distance metric between outputs of repeated executions. In some examples, the operational metrics framework may re-evaluate the regime selection periodically or upon detecting changes in workflow execution frequency, language model pricing, or language model behavior, enabling the system to adapt its regime selection as conditions change over the deployment lifetime.

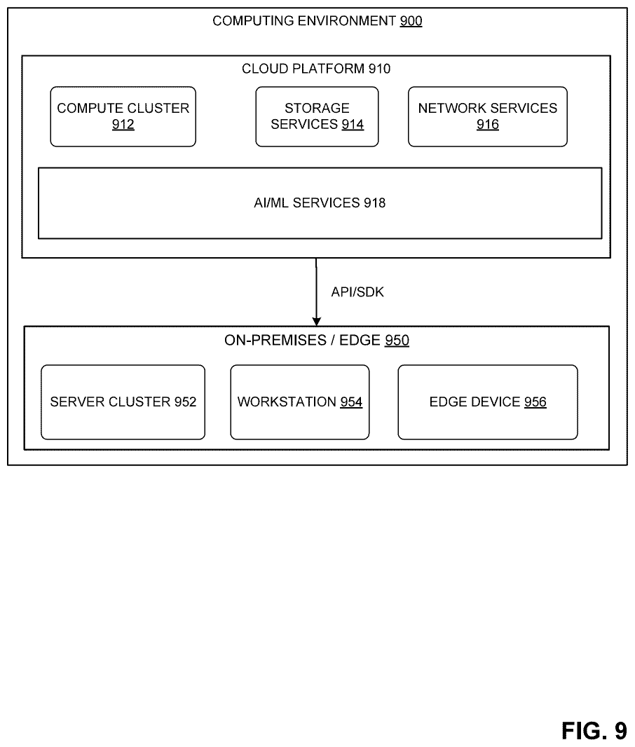

FIG. 9 illustrates a block diagram of a computing environment, in accordance with example embodiments of the disclosure. The computing environment 900 may comprise a cloud platform 910 and optionally one or more on-premises or edge computing resources 950.

The cloud platform 910 may comprise a compute cluster 912, storage services 914, network services 916, and AI/ML services 918.

The compute cluster 912 may provide computational resources for executing the code generation system. In various examples, the compute cluster 912 may comprise virtual machines, container orchestration systems, or serverless computing resources.

The storage services 914 may provide persistent storage for workflow specifications, templates, modules, prompt blocks, generated code artifacts, and operational data. In various examples, the storage services 914 may comprise object storage, block storage, or database services.

The network services 916 may provide connectivity and traffic management. In various examples, the network services 916 may comprise load balancers, API gateways, and content delivery networks.

The AI/ML services 918 may provide language model inference capabilities. In various examples, the AI/ML services 918 may comprise language model inference endpoints, model hosting infrastructure, and GPU or TPU acceleration resources.

The cloud platform 910 may communicate with external systems and optionally with the on-premises or edge computing resources 950 via an API/SDK interface.

The on-premises or edge computing resources 950 may optionally provide local computational resources. In various examples, the on-premises resources 950 may comprise server clusters 952, workstations 954, or edge devices 956. The code generation system may execute in the cloud platform 910, on-premises, or in a hybrid configuration.

In some examples, all operations described herein may be performed by a single computing system operated by a single entity. For example, the code generation system 102, including the configuration agent 110, the component library 108, the language model interface 150, the validation pipeline 160, and the artifact repository 170, may execute on a single server or cluster operated by a single organization. The single computing system may receive workflow specifications from clients, assemble generation context, invoke the language model, execute the validation pipeline, store validated code artifacts, compute operational metrics, and execute deployed artifacts, with all operations performed within the single computing system under the control of the single entity.

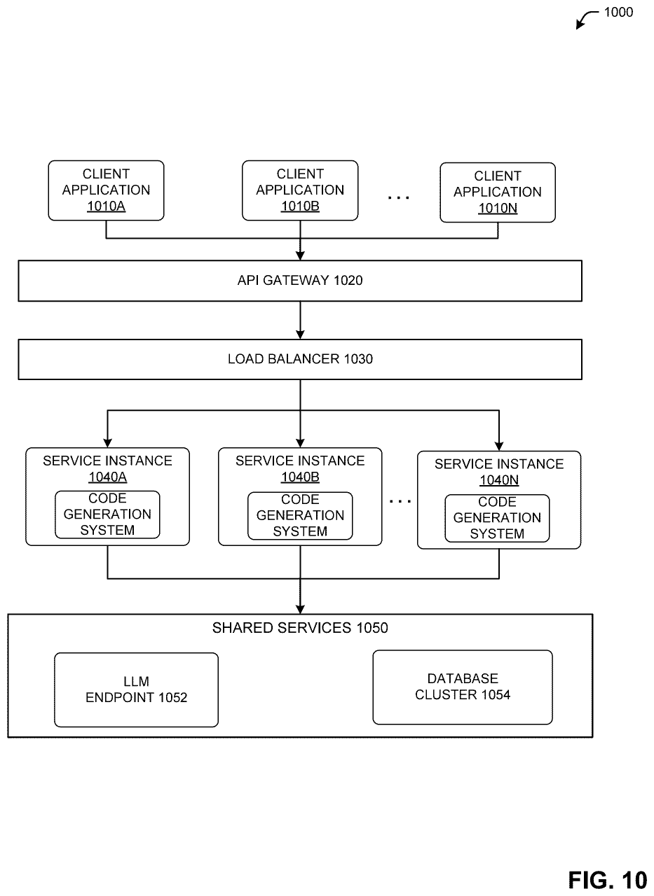

FIG. 10 illustrates a block diagram of a network architecture, in accordance with example embodiments of the disclosure. The network architecture 1000 may comprise client applications 1010A, 1010B, through 1010N, an API gateway 1020, a load balancer 1030, service instances 1040A, 1040B, through 1040N, and shared services 1050.

Client applications 1010A, 1010B, through 1010N may transmit requests to the code generation system. In various examples, client applications may comprise web applications, mobile applications, command-line interfaces, or programmatic API clients.

The API gateway 1020 may receive requests from client applications and may provide authentication, rate limiting, and request routing. The API gateway 1020 may validate credentials and may enforce access control policies.

The load balancer 1030 may distribute requests across service instances 1040A, 1040B, through 1040N. The load balancer 1030 may monitor health of service instances and may route traffic away from unhealthy instances.

Service instances 1040A, 1040B, through 1040N may execute the code generation system. Each service instance may comprise an instance of the code generation system including the configuration agent, template library, module library, prompt block library, and validation pipeline.

Shared services 1050 may provide common capabilities to the service instances. The shared services 1050 may comprise a language model endpoint 1052 for language model inference and a database cluster 1054 for persistent storage of workflow specifications, templates, and generated artifacts.

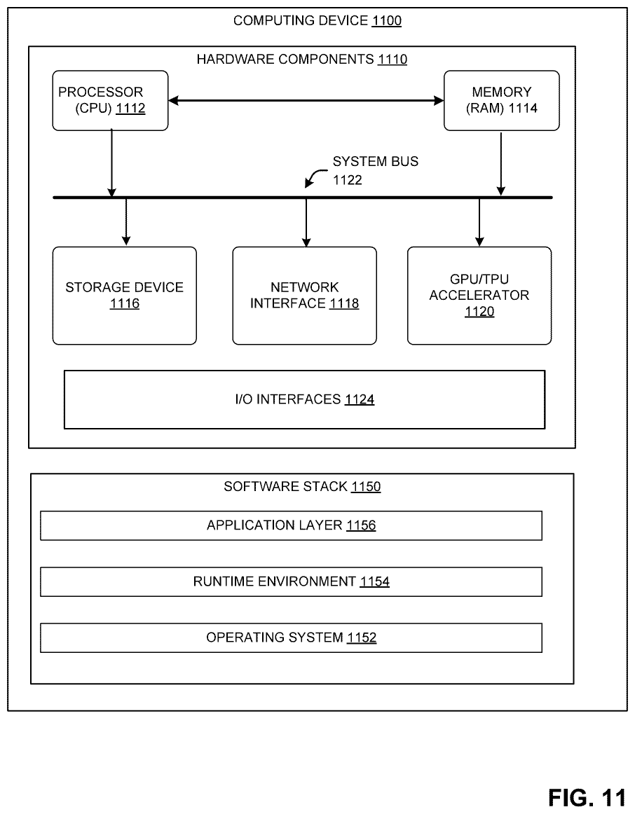

FIG. 11 illustrates a block diagram of a computing device, in accordance with example embodiments of the disclosure. The computing device 1100 may comprise hardware components 1110 and a software stack 1150.

The hardware components 1110 may comprise a processor 1112, memory 1114, a storage device 1116, a network interface 1118, and optionally a GPU/TPU accelerator 1120.

The processor 1112 may comprise one or more processing cores that execute instructions. In various examples, the processor 1112 may comprise a central processing unit (CPU).

The memory 1114 may comprise volatile storage that stores instructions and working data during execution. In various examples, the memory 1114 may comprise random access memory (RAM).

The storage device 1116 may comprise persistent storage that stores programs, data, and files. In various examples, the storage device 1116 may comprise a solid-state drive (SSD) or hard disk drive (HDD).

The network interface 1118 may provide connectivity to other computing devices and networks. In various examples, the network interface 1118 may comprise an Ethernet adapter or wireless network adapter.

The GPU/TPU accelerator 1120 may optionally provide specialized processing capabilities. In various examples, the GPU/TPU accelerator 1120 may comprise a graphics processing unit (GPU) or tensor processing unit (TPU) for accelerating machine learning inference.

A system bus 1122 may interconnect the processor 1112, memory 1114, storage device 1116, network interface 1118, and GPU/TPU accelerator 1120.

I/O interfaces 1124 may provide connectivity for peripheral devices including display outputs, user input devices, and external storage.

The software stack 1150 may comprise an operating system 1152, a runtime environment 1154, and an application layer 1156.

The operating system 1152 may manage hardware resources and may provide services to applications. In various examples, the operating system 1152 may comprise Linux, Windows, or macOS.

The runtime environment 1154 may provide libraries, frameworks, and virtual machines for application execution. In various examples, the runtime environment 1154 may comprise Python runtime, container runtime, or other execution environments.

The application layer 1156 may comprise the code generation system including the configuration agent, template library, module library, prompt block library, language model interface, validation pipeline, and artifact repository.

The following section describes an alternative implementation in which the validated code generation techniques described above may be applied within a multi-agent architecture for generating insights from multiple data domains. The multi-agent insights engine described herein may operate as a standalone system independent of the code factory implementation described above, may operate in conjunction with the code factory implementation, or may operate as a component within the code factory implementation where bounded invocation points may invoke insights engine agents for analytical subtasks. The following description may apply regardless of whether the multi-agent insights engine operates independently or in conjunction with other systems.

In an alternative example, the system may comprise a multi-agent architecture for generating insights from multiple data domains. The multi-agent insights engine may be particularly applicable to healthcare analytics, financial analysis, regulatory compliance assessment, and other domains where information spans multiple specialized knowledge areas that may be synthesized into unified findings. The multi-agent insights engine may be implemented as a backend system that is front-end agnostic, enabling the engine to be licensed for integration into mobile applications, enterprise dashboards, medical record systems, or other products requiring domain-specific analytical capabilities without modification to the engine's core architecture.

The multi-agent insights engine may comprise a plurality of domain-specific agents, each agent specialized for a particular data domain. In a healthcare implementation, the domain-specific agents may include a claims agent specialized for analyzing billing and reimbursement data, an eligibility agent specialized for coverage determination and benefit interpretation, a clinical agent specialized for medical record analysis and diagnosis coding, a formulary agent specialized for pharmaceutical coverage and drug interaction analysis, a prior authorization agent specialized for medical necessity determination and approval workflows, and a provider network agent specialized for network adequacy and credentialing analysis.

In another healthcare implementation, the domain-specific agents may include a genomics agent specialized for DNA sequence analysis and variant interpretation, an epigenetics agent specialized for methylation pattern analysis and gene expression regulation, a metagenomics agent specialized for microbiome composition and diversity analysis, an environmental agent specialized for analyzing pollutant levels, air quality, and weather data and their health correlations, a wearables agent specialized for processing physiological data from wearable devices including heart rate, sleep patterns, and activity levels, and a laboratory agent specialized for interpreting clinical laboratory test results and reference ranges. In yet other implementations, domain-specific agents may be configured for enterprise analytics, consumer wellness, industrial monitoring such as merging sensor data with operational logs, or personalized marketing. The specific agents and their domain specializations are not limited to the examples described herein and may be configured for any domain requiring multi-source analytical synthesis.

Each domain-specific agent may comprise a domain knowledge base, a domain-specific prompt library, and a domain-tuned inference configuration. The domain knowledge base may encode structured knowledge relevant to the agent's specialization, including regulatory requirements, standard operating procedures, decision criteria, and domain-specific terminology. The domain-specific prompt library may contain prompt templates optimized for the agent's analytical tasks, including extraction prompts, classification prompts, comparison prompts, and reasoning prompts. The domain-tuned inference configuration may specify model parameters, context window allocation, and output format requirements appropriate to the domain.

In various examples, domain-specific agents may employ different model architectures suited to their data characteristics. In one example, a domain-specific agent may employ a large language model fine-tuned for structured sequences such as DNA sequences, sensor streams, or environmental timelines. In another example, a domain-specific agent may employ a structured state space model such as Mamba for efficient processing of lengthy data streams. Such models may be efficient for processing lengthy data streams and detecting long-range dependencies in sequential data. In yet another example, a domain-specific agent may employ a mixture of experts architecture in which specialized expert sub-networks may be selectively activated during inference, improving efficiency and accuracy for domain-specific tasks. In some examples, domain-specific agents may employ multi-head latent attention mechanisms that may enhance reasoning depth beyond standard self-attention, or may employ knowledge distillation in which efficient student models may inherit capabilities from larger teacher models, or may employ synthetic data training in which agents may be fine-tuned on synthetically generated datasets to bootstrap specialized reasoning capabilities in domains where labeled training data is scarce. In other examples, domain-specific agents may employ heuristic algorithms encoding domain-specific rules of thumb, or rule-based systems encoding expert-curated thresholds and conditional logic to promote scientific validity alongside model-based reasoning. The model architecture selection for each agent is not limited to these examples and may be determined based on the agent's data characteristics, performance requirements, and domain constraints.

In some implementations, each domain-specific agent may operate as an independent analytical unit capable of generating findings from data within its domain without coordination with other agents. In other implementations, agents may request information from other agents during their analytical process, creating inter-agent dependencies. Hybrid approaches are also possible, where agents may operate independently for initial analysis and may coordinate for cross-domain synthesis.

In some implementations, domain-specific agents may access data through specialized microservices, each microservice dedicated to a particular data type or source. For example, the system may include a health data microservice for managing physiological and clinical data, an environmental data microservice for managing pollutant levels, air quality, and weather data, a document parser microservice for processing unstructured content such as journals, clinical notes, and free-text logs, and a laboratory data microservice for managing test results from third-party laboratory integrations. Each microservice may handle validation and normalization of incoming data, including converting units, verifying timestamps, and which may promote consistency across data sources. Each microservice may further handle storage and retrieval using databases suited to the data type, such as time-series databases for sensor data, document databases for unstructured content, and relational databases for structured clinical records. Each microservice may expose a structured API that domain-specific agents may invoke through a dynamic function-calling mechanism.

The dynamic function-calling mechanism may enable domain-specific agents to request data or computation from specialized microservices at inference time. In one example, an agent may generate a structured function call specifying the target microservice, the operation to perform, and the parameters for the operation, and the system may execute the function call and may return the result to the agent's inference context. This function-calling approach may enable real-time data retrieval from microservices during agent analysis, microservices-based modularity where new data sources and services may be introduced without modifying agent architectures, and scalability where additional microservices may be added to the system as new data types or computational capabilities become available. In some examples, the function-calling mechanism may employ structured schemas such as JSON or OpenAPI specifications to define the available operations, parameters, and return types for each microservice, enabling agents to generate well-formed function calls that conform to the microservice interface.

A central orchestrator may coordinate agent outputs and may manage the multi-agent workflow. The orchestrator may comprise a task decomposition module, an agent dispatch module, an output aggregation module, an inconsistency detection module, and a resolution module.

The task decomposition module may receive an analytical request and may decompose it into domain-specific subtasks. In some implementations, the task decomposition module may employ a language model to analyze the request and may identify which domains are implicated. In other implementations, the task decomposition module may apply rule-based routing based on keywords, entity types, or request categories. The task decomposition module may output a task graph specifying which agents should be invoked and in what order, including any dependencies between agent tasks.

The agent dispatch module may transmit subtasks to the appropriate domain-specific agents according to the task graph. The agent dispatch module may manage parallel execution of independent subtasks and sequential execution of dependent subtasks. The agent dispatch module may monitor agent progress and may handle timeout conditions, retry logic, and failure escalation.

The output aggregation module may collect outputs from the domain-specific agents and may assemble them into a unified response structure. The output aggregation module may align outputs temporally, may resolve reference identifiers across domains, and may format the aggregated output according to the request specification.

The inconsistency detection module may compare findings across agents and may identify inconsistencies between agent outputs. Inconsistencies may include contradictory factual assertions, incompatible date ranges, mismatched entity references, conflicting recommendations, or disagreement on classification outcomes. The inconsistency detection module may output an inconsistency report identifying each detected inconsistency, the agents involved, the specific outputs that conflict, and a severity classification.

The resolution module may process the inconsistency report and may generate resolution actions. Resolution actions may include re-querying one or more agents with additional context, requesting clarification from a specific agent, applying a precedence rule that favors one agent's output over another, synthesizing a reconciled finding that accounts for both perspectives, or escalating to human review. The resolution module may select among resolution actions based on inconsistency type, severity, and configured resolution policies.

In some implementations, the orchestrator may perform cross-domain reasoning that synthesizes findings from multiple agents into higher-order insights not available from any single agent. Cross-domain reasoning may identify patterns that span domains, such as a correlation between clinical diagnoses and claim denial rates, a relationship between formulary restrictions and prior authorization volumes, a connection between provider network gaps and patient access metrics, or a correlation between environmental exposures and genomic expression patterns.

The orchestrator may employ a cross-domain reasoning agent that may receive aggregated outputs from the domain-specific agents and may generate synthetic findings. The cross-domain reasoning agent may operate on a unified representation of the domain-specific outputs, applying reasoning patterns that span domain boundaries. In some implementations, the cross-domain reasoning agent may be a general-purpose language model with access to all domain outputs. In other implementations, the cross-domain reasoning agent may be a specialized model trained on cross-domain analytical tasks.

Each domain-specific agent may output a confidence score with each finding. The confidence score may represent the agent's assessed reliability of the finding based on factors including data completeness, source authority, reasoning chain length, and consistency with known patterns. Confidence scores may be numeric values on a defined scale, categorical labels such as high, medium, or low, or probability distributions over possible findings.

The orchestrator may aggregate confidence scores across agents to produce an overall confidence assessment for the unified response. In some implementations, the orchestrator may compute a weighted average of agent confidence scores, with weights reflecting the relative importance of each domain to the analytical request. In other implementations, the orchestrator may apply a minimum function, such that the overall confidence may be limited by the lowest-confidence contributing finding. In yet other implementations, the orchestrator may employ a learned aggregation function trained on historical accuracy data.

When agent confidence scores fall below a configured threshold, the orchestrator may trigger additional processing. Low-confidence findings may be flagged for human review, may be subjected to additional validation steps, or may be excluded from the response with an indication that the finding could not be determined with sufficient confidence.

In one example, the multi-agent insights engine may employ validation-oriented retrieval to verify agent findings before inclusion in the final output. An agent may generate a candidate finding based on its domain analysis. The system may formulate a validation query scoped to the candidate finding. The validation query may be transmitted to a retrieval system that may search for supporting or contradicting evidence in authoritative sources.

The retrieval system may search internal knowledge bases, external reference databases, regulatory guidance documents, clinical literature, or other authoritative sources depending on the domain and finding type. The retrieval system may return evidence items along with relevance scores indicating how closely each item relates to the candidate finding.

A validation evaluator may assess the retrieved evidence and may determine whether the candidate finding is supported, contradicted, or neither. Supported findings may be included in the final output with an indication of validation status. Contradicted findings may be either excluded, revised based on the contradicting evidence, or flagged for resolution. Findings with insufficient evidence may be included with reduced confidence scores or may be flagged as unvalidated.

In some implementations, the validation evaluator may be a rule-based system that matches evidence patterns against finding types. In other implementations, the validation evaluator may be a language model that reasons about the relationship between the candidate finding and the retrieved evidence.

In one example, the multi-agent insights engine may employ a feedback loop that may improve agent performance over time. Agent outputs may be validated against external references, including ground truth labels from resolved cases, expert annotations, outcome data from downstream processes, or user feedback indicating finding accuracy.

A reward signal may be computed from validation results. Positive reward may be assigned when agent findings are confirmed by external validation. Negative reward may be assigned when agent findings are contradicted by external validation. The magnitude of reward may reflect the importance of the finding, the confidence the agent expressed, and the delay between finding generation and validation.

Agent parameters may be updated based on accumulated reward signals. In some implementations, parameter updates may occur through fine-tuning of the agent's underlying language model. In other implementations, parameter updates may adjust the agent's prompt library, modifying prompt templates to improve performance on finding types where the agent has historically underperformed. In yet other implementations, parameter updates may adjust the agent's retrieval configuration, modifying search parameters to improve access to relevant information.

In one example, the feedback loop may employ a group relative policy optimization approach in which a group of agent outputs for a given analytical task may be evaluated relative to each other rather than against absolute labels. Reward signals may be computed based on the relative performance of outputs within the group, such that higher-performing outputs may receive positive reward and lower-performing outputs may receive negative reward. This group-relative approach may enable agent improvement without requiring human-labeled training data, because the reward signal may be derived from comparative evaluation across the group rather than from externally provided ground truth labels. In some examples, the group relative policy optimization may be applied across multiple agents simultaneously, enabling collective policy improvements where agents may learn from each other's relative performance on shared or overlapping analytical tasks. In other examples, the group relative policy optimization may be applied to multiple outputs from a single agent, enabling the agent to improve by comparing its own outputs across different parameter configurations or prompt variations.

The feedback loop may enable iterative refinement of agent behavior, such that agents may improve their accuracy and calibration over time as validation data accumulates.

In one example, the multi-agent insights engine may maintain state across analytical iterations for ongoing cases or longitudinal analysis. Each iteration's agent outputs may be stored with version identifiers in a state repository. The state repository may associate outputs with timestamps, agent identifiers, input data versions, and configuration versions.

The system may support retrospective retrieval of agent outputs across iterations, enabling analysis of how findings evolved over time. A longitudinal analysis module may compare findings from different iterations to identify changes, trends, and anomalies. For example, the system may detect that a clinical agent's diagnosis assessment changed between iterations due to new clinical documentation, or that an eligibility agent's coverage determination changed due to a policy update.

In some implementations, agents may have access to their own prior outputs when processing new iterations, enabling continuity of reasoning across iterations. In other implementations, agents may operate statelessly on each iteration, with longitudinal analysis performed by the orchestrator rather than by individual agents.

The multi-agent insights engine may support human-in-the-loop workflows for cases requiring human judgment, expertise, or oversight. Escalation triggers may include low aggregate confidence scores, detected inconsistencies that may not be automatically resolved, findings with high consequence that require human verification, or explicit user requests for human review.

When escalation is triggered, the system may route the case to a human review queue. The human reviewer may receive the aggregated agent outputs, the inconsistency report if applicable, the confidence scores, and the underlying data and evidence. The human reviewer may confirm findings, may override findings, may provide additional guidance, or may request additional agent analysis.

Human reviewer actions may be captured and fed back into the feedback loop, providing high-quality training signal for agent improvement. Human overrides may indicate cases where agent findings were incorrect, while human confirmations may indicate cases where agent findings were correct despite low confidence or detected inconsistencies.

The multi-agent insights engine may generate structured outputs that synthesize findings from all contributing agents. Output formats may include narrative summaries, structured reports, data tables, visualizations, or machine-readable data objects depending on the request specification and downstream consumption requirements.

In some implementations, a report generation agent may produce natural language summaries from the aggregated structured findings. The report generation agent may apply domain-appropriate terminology, formatting conventions, and explanation depth based on the intended audience. In other implementations, the output aggregation module may directly format structured outputs without natural language generation.

Outputs may include provenance information tracing each finding to its source agent, the data that supported it, the confidence assessment, and any validation or resolution steps that were applied. This provenance information may support auditability, enabling downstream consumers to understand how findings were derived and to investigate questionable results.

When deployed together, the multi-agent insights engine and the code factory implementation may share a validation-oriented approach. Both implementations may validate outputs against defined criteria and may employ feedback mechanisms for iterative improvement. Both implementations may support human-in-the-loop escalation for cases exceeding automated processing capability. Both implementations may maintain structured artifacts (code artifacts in the code factory, finding artifacts in the insights engine) that may be generated, validated, and consumed by downstream processes.

The code factory implementation may generate code artifacts for workflow automation, with validation that may promote code correctness before deployment. The multi-agent insights engine may generate analytical findings from multi-domain data, with validation configured to verify accuracy of findings before inclusion in outputs. The validation pipeline of the code factory implementation (security, syntax, execution, accuracy) may correspond functionally to the validation stages of the insights engine (source verification, consistency checking, cross-reference validation, confidence assessment).

In some implementations, the code factory and multi-agent insights engine may be deployed together, with the code factory generating workflow automation code and the insights engine providing analytical capabilities that the generated workflows may invoke. The bounded invocation points of code factory artifacts may invoke insights engine agents for classification, extraction, or summarization subtasks, with schema validation and fallback logic configured to promote deterministic workflow behavior regardless of agent output characteristics.

However, the multi-agent insights engine may also be deployed independently without the code factory, operating as a self-contained analytical system that receives analytical requests, coordinates domain-specific agents, and produces validated findings without code generation or artifact deployment. In such independent deployments, the multi-agent insights engine may expose its own API for receiving requests and returning findings, may manage its own agent lifecycle and configuration, and may operate its own feedback loop for agent improvement, without dependence on the code factory's template architecture, validation pipeline, or regime selection framework.

The following section describes AI integration and technical improvement considerations applicable to the disclosed system as a whole, including both the code factory implementation and the multi-agent insights engine implementation.

The disclosed code generation system may differ fundamentally from conventional code generation architectures because its core generative behavior may be governed not by static template expansion, developer-authored code, or runtime scripting engines, but by inference-time code generation where a language model may produce executable code within structurally constrained boundaries. Whereas conventional systems either require developer involvement in the authorship loop for each workflow or invoke language models at runtime for every execution, the disclosed system may shift the locus of code authorship from static, developer-time creation to dynamic, model-mediated generation conditioned on workflow specifications and component context. The language model may be invoked once during a generation phase to produce code within a bounded insertion region of a selected template, and the resulting code artifact may be validated through sequential validation stages before deployment for repeated execution. This inference-time generation, followed by validation and deployment, may establish a computational paradigm in which the language model serves as a bounded generative component whose output may be structurally contained, stage-validated, and deployed as stored code, rather than as a runtime interpreter that must be re-invoked for every workflow execution.

The disclosed system may embody a materially different and technically novel class of code generation architecture. Unlike prior code generation systems that treat validation as a single pass/fail gate, that rely on the language model to generate compliant code directly, or that permit unconstrained runtime language model calls, the disclosed system may unify code generation, structural compliance enforcement, stage-identified validation, and bounded runtime invocation within a single architecture governed by inference-time artifacts. At the core of this distinction may be new computational artifacts and control flows: generated code segments produced by the language model within bounded insertion regions of compliance-enforcing templates; error context objects that encode stage-identified validation failures with categorical diagnostic information; schema-validated outputs from bounded invocation points where runtime language model calls may be contained within observable boundaries; and operational metrics that may condition regime selection between deploying stored code artifacts and executing by runtime inference. These artifacts may not be post-hoc logs or final outputs; they may be first-class, inference-time data objects whose generation, transformation, and consumption by subsequent processing steps may be integral to the disclosed system's algorithmic operation. The language model may generate these artifacts during the code generation and validation cycle, and downstream components, including the validation pipeline, the regeneration feedback loop, the deployment selector, and the runtime execution engine, may consume them to determine execution paths, trigger regeneration, select operational regimes, and invoke fallback logic.

The disclosed system may couple language model generation and code deployment by using a language model as a constrained, inference-time code generator within a template architecture that may structurally enforce compliance requirements. In conventional code generation systems, an external developer or scripting engine authors business logic and manually ensures compliance with applicable regulatory frameworks. By contrast, the disclosed system may invoke a language model to generate code within an insertion region of a code structure encoding a compliance requirement, the insertion region bounded by compliance-enforcing code segments corresponding to the compliance requirement. The compliance-enforcing code segments, positioned in fixed header and footer regions of the template outside the bounded insertion region, may execute regardless of what the language model generates within the insertion region. The insertion region may be enforced through multiple mechanisms: at generation time, the language model interface may instruct the language model to produce code within boundary markers; at assembly time, the system may extract code between the boundary markers and discard content outside the boundary markers; and at validation time, the system may verify that the generated code does not modify state outside the insertion region, such as overwriting template functions, modifying global state, or monkey-patching module interfaces. This three-layer enforcement may be configured such that the language model's output is structurally contained regardless of what the model produces, and that compliance-enforcing code segments may execute without dependence on the language model's awareness of regulatory requirements, its ability to implement those requirements correctly, or the completeness of compliance instructions in the generation context. Because the compliance-enforcing code segments may not be subject to the variability inherent in language model generation, the disclosed system may provide a structural compliance property that may be stronger than approaches that rely on the language model to generate compliant code directly or that perform post-hoc compliance checking on generated output.

The disclosed system may further introduce stage-identified error context generation as a first-class computational mechanism that may materially change how the validation and regeneration cycle operates. Prior validation systems handle error diagnosis using single-pass validators that report binary pass/fail results, or multi-check validators that aggregate all failures into undifferentiated error lists. These prior mechanisms may not distinguish failure types, requiring developers or language models to diagnose whether a failure stems from security violations, syntax errors, runtime exceptions, or output accuracy problems. The disclosed system may replace undifferentiated error reporting with a sequential validation pipeline comprising a plurality of validation stages, each evaluating the generated code against criteria specific to that validation stage. Upon failure at a validation stage, the system may generate an error context object, a first-class computational artifact encoding the failed stage identifier and stage-specific diagnostic information such as line numbers, error messages, failing test case identifiers, or suggested fix patterns. This error context object may be consumed by the regeneration feedback loop, which may provide it to the language model to condition the next generation attempt. Because the error context may identify the specific validation stage at which the generated code failed, the language model may receive categorical feedback about what type of fix is needed, enabling the model to focus its regeneration on the relevant failure mode rather than re-examining the entire code artifact for all possible problems. This targeted regeneration may change the computational behavior of the validation cycle by reducing the number of language model inference invocations that may be required to converge on valid code. Each avoided regeneration attempt may reduce or eliminate the token consumption, inference latency, and computational resources of a full language model invocation, producing a direct and measurable reduction in GPU or TPU inference cycles, memory bandwidth consumption for model input processing, and network round trips to inference endpoints during the generation phase.

The disclosed system may additionally introduce bounded invocation points as a computational mechanism that may contain runtime language model non-determinism within observable and controllable boundaries. Prior systems handle runtime language model invocation using unconstrained API calls where model outputs flow directly into downstream processing, or using static exception handlers that catch failures after they propagate. These prior mechanisms either permit non-deterministic model outputs to affect system state without bounds, or require developer-authored exception logic for every anticipated failure mode. The disclosed system may replace unconstrained invocation with bounded invocation points defined within the validated code artifact, each comprising an invocation definition, an input schema, an output schema, and fallback logic. At each invocation point, the system may validate input against the input schema prior to transmitting input to the language model, rejecting malformed requests before incurring inference cost. Upon receiving output from the language model, the system may validate the output against the output schema. The output schema may be a first-class computational artifact that may gate whether the language model's output enters downstream processing. Upon the output failing validation against the schema, the system may execute fallback logic defined within the code artifact, comprising deterministic operations such as returning a default value, retrying with modified input, or routing to a human review queue. Because bounded invocation points may scope runtime language model calls to narrow, well-defined subtasks such as classification, extraction, or summarization, the prompts transmitted to the language model at invocation points may be substantially smaller than the prompts that would be required for runtime inference of the entire workflow specification. This may produce a direct reduction in per-invocation token consumption and inference latency compared to runtime inference approaches that process the full workflow specification on every execution. The schema validation and fallback logic may further be configured such that all code paths downstream of invocation points may execute deterministically regardless of language model output characteristics, reducing or eliminating the need for defensive error handling throughout the downstream code and producing more predictable memory allocation patterns, execution timing, and resource utilization in the deployed artifact.

The disclosed system may further introduce an operational metrics framework that may replace static regime selection with computed regime selection based on inference-time economic analysis. Prior systems handle the decision between generating code and invoking language models at runtime using static configuration, developer judgment, or organizational policy applied uniformly across workflows. These prior mechanisms may not adapt to per-workflow economics, applying the same execution strategy to high-frequency workflows and low-frequency workflows alike. The disclosed system may compute an operational metric relating the cost of generating a code artifact by a language model from a workflow specification to the cost of executing the workflow specification by runtime language model inference, and may select between deploying the code artifact and executing by runtime inference based on the operational metric. The operational metric may comprise a break-even threshold determined based on the generation cost and the cumulative runtime inference cost across a number of executions. Upon the expected number of executions and the break-even threshold indicating that artifact deployment is more economical, the system may deploy the code artifact for execution from stored code. Upon the expected number of executions and the break-even threshold indicating that runtime inference is more economical, the system may select runtime inference. This per-workflow regime selection may change the computational resource allocation of the system by directing high-frequency workflows to execute from stored code artifacts that may consume no inference tokens, no GPU or TPU cycles for language model invocation, and no network bandwidth to inference endpoints per execution, while directing low-frequency workflows to runtime inference that may avoid the upfront computational cost of generation and multi-stage validation. The regime selection may further consider an output variability measure representing variation in outputs across repeated runtime inference executions, favoring artifact deployment when inference outputs are highly variable, because output variability may introduce additional computational cost in the form of inconsistent downstream processing, repeated error handling, and audit trail inconsistencies. By computing this selection per workflow rather than applying a uniform policy, the system may optimize aggregate computational resource consumption across a portfolio of workflows.

The disclosed system may further address computational constraints inherent in transformer-based language model inference, including per-inference token cost, inference latency, and output non-determinism, through the bounded insertion region that may constrain generation scope to business logic rather than full application code, the stage-identified feedback that may reduce regeneration iterations, and the schema-validated invocation points that may contain runtime non-determinism within narrow subtask scopes. The bounded insertion region may constrain the language model's generation scope to a process function of approximately 20 to 50 lines of business logic, rather than requiring the language model to generate an entire application including infrastructure, initialization, error handling, and compliance code. This scope constraint may directly reduce the number of output tokens generated per invocation, reducing inference latency and GPU memory consumption during generation. The template architecture may place infrastructure, initialization, compliance, and cleanup code in fixed regions that may be authored once and reused across many workflow specifications, amortizing the human authorship cost and reducing or eliminating redundant inference-time generation of boilerplate code. The stage-identified validation pipeline may provide feedback that enables the language model to remediate specific failure categories without regenerating the entire code artifact, reducing the average number of inference cycles from generation to deployment. The bounded invocation points may scope runtime language model calls to narrow subtasks with small, targeted prompts, rather than transmitting the entire workflow specification on every execution, reducing per-transaction token consumption and inference endpoint load.

Collectively, these AI mechanisms may establish a system in which the language model is not a peripheral enhancement applied to an otherwise conventional code generation system, but an architecturally integral generative layer whose runtime artifacts, including generated code within structurally constrained insertion regions, stage-identified error context for targeted regeneration, schema-validated outputs at bounded invocation points, and computed operational metrics for regime selection, may determine execution paths, trigger regeneration cycles, gate runtime behavior, and select deployment strategies throughout the disclosed system's operation. The AI-generated artifacts may serve as the control signals that unify code generation, validation, compliance enforcement, and runtime containment into a single, inference-driven operational architecture. No single mechanism in isolation may provide the collective improvement: stage-identified regeneration may reduce the generation cost, which may shift the break-even threshold computed by the operational metrics framework, which may change regime selection outcomes across the workflow portfolio; structural compliance containment may reduce or eliminate the need for the language model to generate compliant code, which may reduce regeneration failures attributable to compliance violations and further reduce the generation cost; bounded invocation points may enable deployed artifacts to leverage runtime language model judgment for narrow subtasks without sacrificing the deterministic execution and cost amortization benefits of artifact deployment. These interactions across mechanisms may produce system-level improvements that no individual mechanism provides alone.

The disclosed system's integration of the language model may provide concrete and measurable technical improvement to computer functionality. These improvements may be to how the system itself operates, not merely to the quality of generated code outputs. Specifically, the AI-mediated mechanisms may reduce per-execution computational resource consumption by amortizing generation and validation cost across multiple executions of deployed code artifacts that may execute from stored code without further language model invocation; may reduce total inference cycles during the generation phase by providing stage-identified feedback that enables targeted remediation rather than undifferentiated regeneration; may reduce failure propagation and defensive error handling overhead by containing runtime model outputs within schema-validated boundaries with deterministic fallback logic; and may reduce aggregate computational resource misallocation by computing per-workflow regime selection based on operational metrics rather than applying uniform execution strategies. These improvements may arise from the disclosed system's specific integration of the language model as a bounded generative component, through generated code within structurally constrained insertion regions, stage-identified error context for targeted regeneration, schema-validated outputs at bounded invocation points, and computed operational metrics for regime selection, rather than from abstract processing of information or mere application of language models to code generation tasks. Accordingly, the disclosed system's AI integration may deliver a genuine technical effect grounded in the improved operation of the computer system itself.

The foregoing examples illustrate several ways in which compliance-enforcing template structures, sequential validation pipelines, operational regime selection, and bounded runtime invocation may be combined to achieve validated code generation for enterprise workflow automation. These examples may be mixed and matched; for example, the same deployment can use compliance-encoding templates for HIPAA-regulated healthcare workflows, stage-identified regeneration for targeted error remediation, break-even analysis for per-workflow regime selection, and schema-validated invocation points for runtime language model calls requiring judgment. Together, they may support and enable the full scope of the method and system claims, while also providing concrete technical effects useful to improve the functionality of a computer system. These effects include, but are not limited to: (i) reduced per-execution inference cost by amortizing generation and validation cost across multiple executions of deployed code artifacts, (ii) improved regeneration convergence by providing stage-identified feedback that enables targeted remediation rather than generic retry, (iii) enhanced compliance assurance through structural containment in template architecture rather than reliance on language model behavior, (iv) decreased runtime variability by containing language model non-determinism within bounded invocation points with schema validation and fallback logic, (v) reduced development cost by enabling code generation without developer involvement in the authorship loop for each workflow, and (vi) improved resource allocation by computing per-workflow regime selection based on operational metrics rather than applying uniform execution strategies. These improvements may enable the disclosed systems and methods to achieve more reliable, more scalable workflow automation compared to runtime-inference-only or unvalidated code generation approaches.

It should be understood that any description herein of a method performing an action or function, a system performing an action or function, or an apparatus performing an action or function is not intended to limit the disclosure to any particular statutory class. Descriptions of methods, systems, apparatuses, and computer-readable media are interchangeable, and any feature described in connection with one statutory class provides support for the others. For example, a method step described herein also describes a system or apparatus configured to perform that step, and a computer-readable medium storing instructions that, when executed, cause a processor to perform that step. Similarly, a system or apparatus described as configured to perform an action or function also describes a method comprising that action or function and a computer-readable medium storing instructions to perform that action or function.

Various aspects of the disclosure may be practiced independently or in combination.

The illustrated aspects of the claimed subject matter may also be practiced in distributed computing environments where certain tasks are performed by remote processing devices that are linked through a communications network. In a distributed computing environment, program modules may be located in both local and remote memory storage devices.

### EXAMPLE CLAUSES

Clause 1. A computer-implemented method comprising: computing an operational metric relating a cost of generating a code artifact by a language model from a workflow specification to a cost of executing the workflow specification by runtime language model inference; and selecting, based on the operational metric, between deploying the code artifact and executing the workflow specification by runtime language model inference.

Clause 2. The method of clause 1, wherein the operational metric comprises a break-even threshold determined based on the cost of generating the code artifact and a cumulative cost of executing the workflow specification by runtime language model inference across a number of executions.

Clause 3. The method of clause 2, wherein selecting comprises deploying the code artifact based on an expected number of executions and the break-even threshold.

Clause 4. The method of clause 1, wherein the operational metric further comprises an output variability measure representing variation in outputs across repeated executions of the workflow specification by runtime language model inference.

Clause 5. The method of clause 1, wherein the code artifact, upon deployment, executes the workflow specification from stored code.

Clause 6. A system comprising: one or more processors; and memory storing instructions that, when executed by the one or more processors, cause the system to: invoke a language model to generate code within an insertion region of a code structure encoding a compliance requirement, the insertion region bounded by compliance-enforcing code segments corresponding to the compliance requirement; and output a code artifact comprising the generated code within the compliance-enforcing code segments.

Clause 7. The system of clause 6, wherein the compliance requirement comprises at least one of HIPAA, SOC 2, or PCI-DSS.

Clause 8. The system of clause 6, wherein the compliance-enforcing code segments comprise at least one of: audit logging code, encryption code, or access control code.

Clause 9. The system of clause 6, wherein the generated code is validated by executing a plurality of validation stages in sequence, and upon failure at a validation stage, an error context identifying the validation stage at which the generated code failed is provided to the language model to regenerate the code.

Clause 10. The system of clause 9, wherein the plurality of validation stages comprises at least one of: a security validation stage configured to detect unsafe code patterns, a syntax validation stage configured to verify code structure and type correctness, an execution validation stage configured to execute the code in a sandboxed environment, or an accuracy validation stage configured to compare outputs of the code against reference data.

Clause 11. The system of clause 9, wherein the error context comprises at least one of: a stage identifier indicating the validation stage at which the generated code failed, diagnostic information specific to the validation stage at which the generated code failed, or a line number associated with the failure, and wherein upon a count of regeneration attempts exceeding a threshold, the system routes the code for human review.

Clause 12. The system of clause 6, wherein the instructions further cause the system to select the code structure from a library of code structures indexed by compliance requirement.

Clause 13. The system of clause 6, wherein the insertion region is enforced by instructing the language model to generate code within boundary markers during generation, extracting code between the boundary markers and discarding content outside the boundary markers during assembly, and verifying during validation that the generated code does not modify state outside the insertion region.

Clause 14. A non-transitory computer-readable medium storing instructions that, when executed by one or more processors, cause the one or more processors to: at an invocation point defined within a code artifact generated by a language model and validated prior to deployment, transmit input to a language model and receive output from the language model; validate the output against a schema; and upon the output failing validation against the schema, execute fallback logic defined within the code artifact.

Clause 15. The non-transitory computer-readable medium of clause 14, wherein the schema defines at least one of: required fields, expected data types, or acceptable value patterns.

Clause 16. The non-transitory computer-readable medium of clause 14, wherein the fallback logic comprises at least one of: returning a default value, retrying with modified input, or routing to a human review queue.

Clause 17. The non-transitory computer-readable medium of clause 14, wherein the invocation point comprises a timeout duration, and wherein upon the language model failing to respond within the timeout duration, the instructions cause the one or more processors to execute the fallback logic.

Clause 18. The non-transitory computer-readable medium of clause 14, wherein the invocation point is scoped to a subtask comprising at least one of classification, extraction, or summarization.

Clause 19. The non-transitory computer-readable medium of clause 14, wherein the instructions further cause the one or more processors to validate the input against an input schema prior to transmitting the input to the language model.

Clause 20. The non-transitory computer-readable medium of clause 14, wherein the instructions further cause the one or more processors to monitor an output distribution from the invocation point and trigger regeneration of the code artifact upon detected drift in the output distribution.

Clause 21. The system of clause 6, wherein the code artifact is generated for a specific customer based on customer-specific parameters in the workflow specification, and wherein the code artifact encodes the customer-specific parameters as constants.

Clause 22. The system of clause 6, wherein the code artifact comprises a durable execution workflow configured to execute on a workflow orchestration platform with automatic state persistence and retry semantics.

Clause 23. The system of clause 6, wherein the instructions further cause the system to assemble a generation context comprising the code structure, module imports from a module library, and prompt instructions from a prompt block library.

Clause 24. The method of clause 1, wherein the cost of generating the code artifact comprises a token count consumed during generation by the language model.

Clause 25. The method of clause 1, wherein the cost of executing the workflow specification by runtime language model inference comprises a per-execution token cost multiplied by an expected execution count.

Clause 26. The system of clause 6, wherein the instructions further cause the system to: identify a conflict between component selections implied by the workflow specification; and resolve the conflict by applying a priority rule, selecting a more restrictive option, or flagging for human review.

Clause 27. The system of clause 6, wherein a prompt block is parameterized to accept values from the workflow specification that customize the prompt block for the workflow.

Clause 28. The system of clause 6, wherein the instructions further cause the system to evaluate a size of a generation context against a token limit of the language model, and upon the generation context exceeding the token limit, apply a reduction strategy comprising at least one of: summarizing module interfaces, truncating lower-priority prompt blocks, or selecting a language model with a larger context window.

Clause 29. The system of clause 6, wherein the instructions further cause the system to select a language model from a plurality of language models based on a complexity of the workflow specification.

Clause 30. The system of clause 9, wherein the error context further comprises error information aggregated from all validation stages evaluated, enabling the language model to address multiple issues in a single regeneration attempt.

Clause 31. The system of clause 9, wherein the instructions further cause the system to provide to the language model, during regeneration: the original generation context, the generated code from a failed attempt annotated with lines and error messages, and error context from prior failed attempts.

Clause 32. The system of clause 9, wherein the instructions further cause the system to adjust a temperature parameter for the language model, using a first temperature for initial generation and a higher temperature for regeneration attempts following repeated failures at a same validation stage.

Clause 33. The system of clause 9, wherein the validation pipeline regenerates code at each validation stage before proceeding to a next validation stage, such that by a final validation stage, the code has been corrected for failures encountered in earlier stages.

Clause 34. The system of clause 11, wherein actions taken by a human reviewer are captured and used to improve future code generation.

Clause 35. The system of clause 6, wherein the instructions further cause the system to: detect that the workflow specification is identical or similar to a previously processed workflow specification; and return an existing validated code artifact associated with the previously processed workflow specification.

Clause 36. The system of clause 6, wherein the instructions further cause the system to store metadata with the code artifact, the metadata comprising at least one of: a language model version used for generation, validation results for each validation stage, a count of regeneration attempts, a generation cost, or a timestamp of generation.

Clause 37. The system of clause 6, wherein a code structure is composed from reusable fragments, such that a first compliance fragment encoding a first compliance requirement is combined with a second compliance fragment encoding a second compliance requirement to produce a hybrid code structure encoding both compliance requirements.

Clause 38. The non-transitory computer-readable medium of clause 14, wherein the invocation point specifies a preferred language model and one or more fallback language models, and wherein upon the preferred language model being unavailable, the instructions cause the one or more processors to route the subtask to a fallback language model.

Clause 39. The non-transitory computer-readable medium of clause 19, wherein validating the input against the input schema further comprises sanitizing the input by at least one of: removing personally identifiable information, or truncating input fields exceeding maximum lengths.

Clause 40. The method of clause 1, further comprising estimating the cost of generating the code artifact prior to generation by analyzing a complexity of the workflow specification and historical generation costs for similar workflow specifications.

Clause 41. The method of clause 2, wherein the break-even threshold is adjusted to account for a per-execution cost of bounded invocation points in the code artifact, such that N=Cg/(Cr−Cb), where Cg is the generation cost, Cr is the runtime inference cost, and Cb is the bounded invocation cost.

Clause 42. The method of clause 1, wherein selecting further considers at least one of: a latency requirement, an output consistency requirement, or a compliance requirement, and wherein the selecting favors deploying the code artifact based on the requirement even when an expected number of executions is below the break-even threshold.

Clause 43. A method comprising: detecting an inconsistency between a first output from a first agent and a second output from a second agent; and generating a resolution action responsive to the inconsistency.

Clause 44. The method of clause 43, wherein the first agent processes a first data type and the second agent processes a second data type different from the first data type.

Clause 45. The method of clause 43, wherein the resolution action comprises at least one of: re-querying an agent with additional context, weighting the first output and the second output based on confidence scores, or flagging the inconsistency for review.

Clause 46. The method of clause 43, further comprising aggregating the first output and the second output into a unified output after generating the resolution action.

Clause 47. The method of clause 43, further comprising: decomposing an analytical request into domain-specific subtasks; dispatching subtasks to appropriate agents according to a task graph specifying agent invocation order and dependencies; and collecting outputs from the agents for aggregation.

Clause 48. A method comprising: executing a validation query for a candidate finding from an agent, the validation query scoped to the candidate finding; receiving a validation result from the validation query; and including the candidate finding in an output conditional on the validation result.

Clause 49. The method of clause 48, wherein executing the validation query comprises constructing the validation query from terms extracted from the candidate finding.

Clause 50. The method of clause 48, wherein the validation result indicates one of: validated, refuted, or indeterminate.

Clause 51. The method of clause 48, wherein including the candidate finding conditional on the validation result comprises excluding the candidate finding when the validation result indicates refuted.

Clause 52. The method of clause 48, wherein the validation query is transmitted to a retrieval system that searches at least one of: an internal knowledge base, an external reference database, regulatory guidance documents, or clinical literature.

Clause 53. A method comprising: validating an output from an agent against a reference; computing a reward signal based on the validating; and updating parameters of the agent based on the reward signal.

Clause 54. The method of clause 53, wherein the updating occurs during runtime operation of the agent.

Clause 55. The method of clause 53, further comprising the agent producing a subsequent output after the updating, wherein the subsequent output reflects the updated parameters.

Clause 56. The method of clause 53, wherein the reward signal is computed without human labeling.

Clause 57. The method of clause 53, wherein the reference comprises at least one of: ground truth labels from resolved cases, expert annotations, outcome data from downstream processes, or user feedback indicating finding accuracy.

Clause 58. A system comprising: one or more processors; and memory storing instructions that, when executed by the one or more processors, cause the system to: store, for each of a plurality of iterations, an output from each of a plurality of agents, each output associated with a version identifier; and responsive to a query, retrieve outputs associated with version identifiers across the plurality of iterations.

Clause 59. The system of clause 58, wherein the version identifier comprises a timestamp.

Clause 60. The system of clause 58, wherein the query identifies a specific agent of the plurality, and wherein retrieve outputs comprises retrieving outputs from the specific agent across the plurality of iterations.

Clause 61. The system of clause 58, wherein the instructions further cause the system to generate a comparison of the retrieved outputs to display evolution of an aggregated output across the plurality of iterations.

Clause 62. The system of clause 58, wherein each output is further associated with a validation event identifier linking the output to a corresponding validation result.

Clause 63. The method of clause 43, further comprising: providing aggregated outputs from the first agent and the second agent to a cross-domain reasoning agent; and generating, by the cross-domain reasoning agent, a synthetic finding representing a pattern spanning domains of the first agent and the second agent.

Clause 64. The method of clause 63, wherein the synthetic finding comprises a correlation not available from either the first agent or the second agent individually.

Clause 65. The method of clause 43, wherein the first output comprises a first confidence score and the second output comprises a second confidence score, and further comprising: aggregating the first confidence score and the second confidence score to produce an overall confidence assessment for a unified output.

Clause 66. The method of clause 65, wherein aggregating comprises computing a weighted average of the first confidence score and the second confidence score, with weights reflecting relative importance of domains of the first agent and the second agent.

Clause 67. The method of clause 65, further comprising, upon the overall confidence assessment falling below a threshold, triggering at least one of: flagging for human review, subjecting to additional validation, or excluding from the output with an indication that the finding could not be determined with sufficient confidence.

Clause 68. The method of clause 43, further comprising: upon an escalation trigger, routing a case to a human review queue; receiving from a human reviewer at least one of: a confirmation, an override, or additional guidance; and capturing the human reviewer action as a training signal for agent improvement.

Clause 69. The method of clause 68, wherein the escalation trigger comprises at least one of: a low aggregate confidence score, a detected inconsistency that is not automatically resolved, or a finding with high consequence requiring human verification.

Clause 70. The method of clause 46, wherein the unified output comprises provenance information for each finding, the provenance information comprising at least one of: an identifier of a source agent, data that supported the finding, a confidence assessment, or validation steps applied to the finding.

While the example clauses described above are described with respect to one particular implementation, it should be understood that, in the context of this document, the content of the example clauses can also be implemented via a method, device, system, a computer-readable medium, and/or another implementation.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example implementations of the disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that may direct a computer or other programmable data processing apparatus to function in a particular manner, such that the instructions stored in the computer-readable memory produce an article of manufacture including instruction that implement one or more functions specified in the flow diagram block or blocks. As an example, implementations of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases may be in communication with each other and/or other databases, such as a centralized database, or other types of data storage devices. When needed, data or information stored in a memory or database may be transmitted to a centralized database capable of receiving data, information, or data records from more than one database or other data storage devices. In other implementations, the databases shown may be integrated or distributed into any number of databases or other data storage devices.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A computer-implemented method comprising:
computing an operational metric relating a cost of generating a code artifact by a language model from a workflow specification to a cost of executing the workflow specification by runtime language model inference; and
selecting, based on the operational metric, between deploying the code artifact and executing the workflow specification by runtime language model inference.

2. The method of claim 1, wherein the operational metric comprises a break-even threshold determined based on the cost of generating the code artifact and a cumulative cost of executing the workflow specification by runtime language model inference across a number of executions.

3. The method of claim 2, wherein selecting comprises deploying the code artifact based on an expected number of executions and the break-even threshold.

4. The method of claim 1, wherein the operational metric further comprises an output variability measure representing variation in outputs across repeated executions of the workflow specification by runtime language model inference.

5. The method of claim 1, wherein the code artifact, upon deployment, executes the workflow specification from stored code.

6. A system comprising:
one or more processors; and
memory storing instructions that, when executed by the one or more processors, cause the system to:
invoke a language model to generate code within an insertion region of a code structure encoding a compliance requirement, the insertion region bounded by compliance-enforcing code segments corresponding to the compliance requirement; and
output a code artifact comprising the generated code within the compliance-enforcing code segments.

7. The system of claim 6, wherein the compliance requirement comprises at least one of HIPAA, SOC 2, or PCI-DSS.

8. The system of claim 6, wherein the compliance-enforcing code segments comprise at least one of:
audit logging code,
encryption code, or
access control code.

9. The system of claim 6, wherein the generated code is validated by executing a plurality of validation stages in sequence, and upon failure at a validation stage, an error context identifying the validation stage at which the generated code failed is provided to the language model to regenerate the code.

10. The system of claim 9, wherein the plurality of validation stages comprises at least one of:
a security validation stage configured to detect unsafe code patterns,
a syntax validation stage configured to verify code structure and type correctness,
an execution validation stage configured to execute the code in a sandboxed environment, or
an accuracy validation stage configured to compare outputs of the code against reference data.

11. The system of claim 9, wherein the error context comprises at least one of:
a stage identifier indicating the validation stage at which the generated code failed,
diagnostic information specific to the validation stage at which the generated code failed, or
a line number associated with the failure, and
wherein upon a count of regeneration attempts exceeding a threshold, the system routes the code for human review.

12. The system of claim 6, wherein the instructions further cause the system to select the code structure from a library of code structures indexed by compliance requirement.

13. The system of claim 6, wherein the insertion region is enforced by instructing the language model to generate code within boundary markers during generation, extracting code between the boundary markers and discarding content outside the boundary markers during assembly, and verifying during validation that the generated code does not modify state outside the insertion region.

14. A non-transitory computer-readable medium storing instructions that, when executed by one or more processors, cause the one or more processors to:
at an invocation point defined within a code artifact generated by a language model and validated prior to deployment, transmit input to a language model and receive output from the language model;
validate the output against a schema; and
upon the output failing validation against the schema, execute fallback logic defined within the code artifact.

15. The non-transitory computer-readable medium of claim 14, wherein the schema defines at least one of:
required fields,
expected data types, or
acceptable value patterns.

16. The non-transitory computer-readable medium of claim 14, wherein the fallback logic comprises at least one of:
returning a default value,
retrying with modified input, or routing to a human review queue.

17. The non-transitory computer-readable medium of claim 14, wherein the invocation point comprises a timeout duration, and wherein upon the language model failing to respond within the timeout duration, the instructions cause the one or more processors to execute the fallback logic.

18. The non-transitory computer-readable medium of claim 14, wherein the invocation point is scoped to a subtask comprising at least one of classification, extraction, or summarization.

19. The non-transitory computer-readable medium of claim 14, wherein the instructions further cause the one or more processors to validate the input against an input schema prior to transmitting the input to the language model.

20. The non-transitory computer-readable medium of claim 14, wherein the instructions further cause the one or more processors to monitor an output distribution from the invocation point and trigger regeneration of the code artifact upon detected drift in the output distribution.
